(19) United States
(12) Patent Application Publication
(10) Pub. No.: US 2015/0210389 A1
(43) Pub. Date: Jul. 30, 2015

(54) Human Power-Assisted Articulating-Winged Avian Soaring Platform (HPAAWASP)

(71) Applicant: Douglas C. MURDOCK, (US)

(72) Inventor: Douglas Craig Murdock, Del Mar, CA (US)

(21) Appl. No.: 14/400,711

(22) PCT Filed: May 16, 2013
(86) PCT No.: PCT/US2013/041467

§ 371 Date: Nov. 12, 2014

Related U.S. Application Data
(60) Provisional application No. 61/651,508, filed on May 24, 2012.
(60) Provisional application No. 61/794,834, filed on Mar. 15, 2013.

(51) Int. Cl. B64C 39/02; B64D 47/00; B64C 33/02

(52) U.S. Cl. CPC B64C 39/026; B64C 33/025; B64D 47/00

(57) ABSTRACT

Disclosed is a soaring platform that is based on biomimicry of soaring bird species and provides bird-like steering modalities and includes an air foil made of feather-like battens, articulating wings, a rudder, and modalities to manipulate the leading edge of the platform's wing spars as well as change in the wings shape in-flight.

### RELATED APPLICATIONS

This invention claims the benefit of Provisional patent application Ser. No. 61/651,508 filed May 24, 2012 and Provisional patent application Ser. No. 61/794,834 filed Mar. 15, 2013.

### FIELD OF THE INVENTION

This invention relates generally to flying devices for soaring. More particularly, this invention relates to flying devices for soaring that are to be operated by a single human pilot. Still more particularly, this invention relates to soaring hang glider-like flying platforms that comprise an articulating wing. Even more specifically, this invention relates to personal soaring platforms designed to look like a real bird species and use avian-based wing and rudder structural modalities for flying and piloting the platform.

### BACKGROUND OF THE INVENTION

The following description in this Background section includes information that may be useful in understanding the present invention. It is not an admission that any such information is prior art, or relevant, to the presently claimed inventions, or that any publication specifically or implicitly referenced is prior art.

The art of manned flight has been a fascination of the human race for literally thousands of years. Ancient history suggests that men (Daedalus and Icarus) have flown bird-like in the sky with wings crafted from real seagull feathers and wax. Such bird-like flight is ostensibly one wherein the flight platform comprises the ability to flap the wing structure using human arm musculature for propulsion and wherein the wing's airfoil is constructed of individual battens, i.e., single spars or ‘quills’ sporting planar sections, as in a typical bird feather. If ever such an assembly for manned flight had ever existed, in past ages the mechanism to allow man to truly fly like a bird seems to have not been carried forward or repeated from those bygone eras, . . . ever, and the dream of manned bird-like flight has been left to mythology.

There have been, however, many attempts throughout the more recent ages to place man in the air under his own power. Despite interesting advances in the art of building flying platforms such as, for example, bicycle operated platforms such as the Gossamer (USA), the Daedalus (USA), and the Mozi (China), (i.e., very large wing spanned airfoils propelled by bicycle peddle-powered cranks affixed to a propeller), and now more recently the same type structure with articulating wing instead of a propeller, e.g., the Snowbird (USA), with regard to a flight system that is human-powered, not a single concept to date has seriously attempted to place man in the air as a bird. Instead, the recent history of manned engineless flight systems includes usage of unpowered kite-like structures including hang gliders of variously shaped wings, namely rectangular and triangular (Rogallo), multi-winged craft similar to the Wright brothers' glider, and sail planes. Even with standard Rogallo and rectangular winged hang gliders, no meaningful advancements have been made to alter the basic nature of flight control modalities, their structures, or otherwise, in nearly one hundred years. The standard hang glider design with its pendulum-like pilot positioning has been the norm since the late 1800's and is inherently unstable and control of the platform is heavily dependent upon the pilot's sensitivity to shifting his body weight under the glider airfoil canopy.

Later methodologies for manned flight in the soaring vein of flight include the paragliders and base jumping suits. Base jumping suits necessitate the need for a parachute due to the fact that the pilot cannot slow down to stop so must break his/her fall with a parachute. Recently, one extreme sports enthusiast has attempted to land with a base jumping suit without a parachute by plowing into a ¼ mile line of cardboard boxes. Such methodology for safe landing is not practical and government regulations regarding parachuting prohibit the use of wing-like mechanical devices extending beyond the length of a person's arms, which regulation precludes any hope for a means to land using a base-jumping suit without a parachute. Paragliders, on the other hand, are essentially parachutes. Paragliders, with their long spaghetti of lines, can be dangerous in high wind conditions and are prone to twist up collapsing the sail, or the sail itself can collapse in high degree banking or from unexpected downdrafts.

Given the limited ability to control and maneuver present personal soaring craft and the need for improving the safety of present soaring platforms, there is substantial room for improvement, particularly in the area of increasing stability and agility in the performance of personal soaring craft. Thus, there is still a need in the arts for personal flying platforms that avoid the necessity of weight shifting for controlling the craft as well as ultimately a parachute. The present invention has industrial applicability in that it provides for solving the ability to control a hang glider-like flying platform with avian control modalities.

### SUMMARY OF THE INVENTION

The present invention comprises a novel avian-based flight control platform and system for application to personal soaring platforms and represents a first in practical application of avian biomimicry in the soaring arts. In a first embodiment, the soaring platform possesses articulating wings and rudder, and feather-like battens forming the flight airfoil surfaces, a configuration as a whole mimicking a natural bird. In a related embodiment, the wings are hinged and can collapse or fold up in the same manner as with avian anatomy. In preferred embodiments, wing articulation and piloting capability is brought about, in part, by the action of cams, levers, gears, springs, wires and cables. In a particularly preferred embodiment, with respect to cams, the platform is capable of achieving large in-flight wing swing adjustments using a plurality of matching pairs of single tooth/groove cams referenced collectively herein as ‘Singularity’ cams times two, or squared or alternatively ‘S2.’ In a specific embodiment, the two cams in a pair have either a tongue ‘S2t,’ or a groove ‘S2v.’

In a second embodiment, the soaring platform can allow a pilot of the platform to fly in a manner similar to hang gliders along a cliff or hill face where there is an up draft of air. Further, this platform allows the pilot to fly away from a cliff or hill face like a bird by articulating the wings of the platform. In further related embodiments, the pilot can maneuver the craft with exceptional agility due to the multiple wing articulating modalities that mimic avian wing movements.

Turning now to further embodiments of the avian soaring platform, the platform comprises multiple components including, but not limited to, 1) a single spar structure per wing that comprises three sections the relative lengths of which mimic the natural ratio between an avian species humerus, radius, and carpal; 2) a body/leg harness; 3) a singular aftward spar comprising at least a foot-operated pedal for rudder manipulation; 4) an air foil batten system for each of the wings and rudder; 5) a wing articulation reciprocator system; 6) a wing articulating hand gimbal steering system; 7) a wing surface area dousing system; 8) a buoyancy compensation system; 9) an electronics system with heads up helmet screen display and button touch pad next to hand gimbals. Other elements include, where warranted, 10) military hardware chaise for equipment related to reconnaissance and targeting.

In preferred embodiments, the platform's rigid skeletal structure can comprise light weight materials such as carbon fiber, aluminum, titanium and the like. Similarly, the airfoil batten material can comprise honeycomb composite, carbon fiber, polystyrene materials such as Mylar™ or the like. In an alternate embodiment, the airfoil material is contemplated to comprise natural based materials such as beta keratin that has been cross-linked and crystallized. In a preferred embodiment, the airfoil material is formed into feather-like battens of dimensions appropriate for a scale ratio with that of an avian of the same or similar species designed generally to the scale of the present platform. Typically, hang glider type craft have a wingspan generally in the range of 25 to 37 feet and airfoil area ranging between 12 and 17 square meters. The present platform contemplates a generally similar range of wing span and an airfoil area, more typically an airfoil area of greater than 15 sq meters (m²) for a platform supporting a 25 foot wingspan and 18 m² for a platform supporting a 30 foot wingspan, for example. Thus, it is contemplated that the present soaring platform will have generally a greater wing surface area than a hang glider styled craft with an equivalent wingspan. In a further related embodiment, the batten structures are textured with linear striations molded and/or etched into the batten material on both the top and bottom surface thereof and at oblique angles to the support spar. For some airfoil battens the support spar extends centrally the length of the batten and in alternate embodiments for other battens the support spar lies distinctly laterally from center the length of the batten as noted in FIG. 23. Battens with offset spars are generally considered equivalents of avian flight or primary feathers and are intended to provide lift as they are themselves airfoil shaped.

In another embodiment, the batten placement and configuration along the length of right and left wing spars comprises a set range of number of battens comprising between one and five Tertiary battens per right and left wing that are placed along the inner most length or humerus of the wing spars (i.e., area nearest the body), between four and ten Secondary battens that are placed along the middle length or radius of each left and right wing spar, and between four and ten Primary battens that are placed along the outer lengths or carpal of the right and left wing spars.

In another embodiment, the soaring platform comprises a rudder that is fan-like in that it can be collapsed to a straight in-line format and expanded to spread out like a Japanese hand fan. In preferred embodiments, the rudder is operated by a multi-component foot pedal rudder control system. The rudder comprises between two and ten battens that are divided into two equally numbered mirrored left and right sets of between generally, one and five battens each, more typically between two and four battens each. In preferred embodiments, the pedal drive comprises a module that applies the power of leverage, cams and springs to modulate in-part the shape and position of the rudder.

In further embodiments, the soaring platform is piloted using multi-component hand gimbals located at a distance along the inner-most wing spar sections of both left and right wings. The hand gimbals are designed to allow a pilot to 1) articulate the wing in a flapping motion, 2) modulate the attack angle of the wing leading edge of the wing to oncoming air, 3) modulate in-flight the angular positioning of all three wing spars, and 4) modulate in-flight the Primary battens' attack angle to oncoming air. The hand gimbals operate in mirror fashion with one another meaning that for similar movements in the left and right wing, the hand movements on the gimbals are mirrored. For example, if the right wing angle of attack with respect to oncoming air stream is increased by rotating the right gimbal counterclockwise, the left wing increased angle of attack is performed by rotating the left gimbal clockwise. Whether clockwise rotation or counterclockwise rotation is desired for increasing or decreasing attack angle, either can be designed for use as desired by preference of the pilot. The platform is further piloted using the fan-like rudder which is operated by foot. Thus, there are at least five distinct modalities a pilot can manipulate to alter moments of inertia to direct the craft's direction of flight.

In still other embodiments, the wings of the platform can be articulated in a flapping motion wherein the motion is not simply a movement straight up and down like a see-saw about a fulcrum but rather in a rotated fashion such that when the wing is swung in a downward direction the leading edge is rotated or roiled downward, meaning that as viewed by facing the platform from its right side, the platform lying horizontal like a flying bird, when the wing is brought down the spar will rotate about an arc in a clockwise direction. Facing the platform from its left side, the platform lying horizontal like a flying bird, when the wing is brought down, the left wing spar will rotate about an arc in a counterclockwise direction. When the wings are brought from a downward position to an upward resting or soaring position, the leading edge of the wings are rotated up which will be the opposite movement described above in the downward rotation of the wing.

In other preferred embodiments, the soaring platform comprises a novel means for articulating the wing in a flapping-like manner. The means can comprise a reciprocator defined as a mechanical configuration designed to make back and forth movement of a dynamic element. In preferred embodiments, the dynamic element of the present reciprocator comprises a novel mechanism that translates a reciprocation vector force from a lateral or zero degree movement into a vector force up to ninety degrees from the lateral zero degree motion. In further related embodiments, the reciprocator is contemplated to be powered by any of electric motor drives such as servos, compressed gas discharge (e.g., CO2 or 02, or N2), gas pressure based explosion (e.g., an internal combustion motor, and a combustable charge such as from a firearm blank shell casing), and windable coil or tension springs. In further related embodiments, where the power source is spring driven, the rewinding of said spring is operated by a foot operated ratchet that can be pumped during flight to restore power assist to the wing articulation (reciprocator) mechanism.

In other embodiments relating to wing articulation and in-flight angular adjustment of the wings, the platform can use single toothed cam pairs (S2 cams) to accomplish, in-part, wing flapping and wing dousing.

In additional embodiments, when the wing is not articulated to flap but instead is to be articulated by rotation of the wing spar without flapping, the pilot can manipulate the hand gimbals to adjust the relative angle of attack of the leading edge of the airfoil with the oncoming airstream. Further, the pilot can manipulate the shape of the airfoil by collapsing and expanding all three sections of the wing spar in-flight as well as the angle of attack of the Primary battens that are attached to the outer wing spar.

In further embodiments, the platform comprises a body harness around which other elements of the platform are configured. In preferred embodiments, the harness comprises a vest-like framing that comprises a firm dorsal back plate upon which the reciprocator element is attached. The vest includes at its lower section a crotch and thigh wraps so that when the platform is placed on the body the configuration is similar to a ‘farmer john’ wet suit, i.e., a thigh length sleeveless vest. In still further embodiments, the harness is attached through the dorsal back plate to a rudder/foot pedal spar that is hinged near the waist. In preferred embodiments, the hinge is lockable and is spring loaded to resist articulation up to a defined force as one of skill in the arts will readily understand and allows articulation easily when force greater than the resistance limit is applied. Specifically, the articulation of the foot pedal spar can be swung ventrally such as the movement of swinging the legs forward from a standing to a sitting position and back to standing.

In still additional embodiments, the soaring platform comprises a system for buoyancy compensation defined as a system for reducing or increasing apparent dead weight of the platform and human operator. In preferred embodiments, the buoyancy system comprises a plurality of shaped closed gas impermeable pockets for filling with lighter-than-air gas such as H2 or He2. In particularly preferred embodiments, the closed pockets are interconnected through gas impermeable tubing to a central fill and empty port that is capable of directing inflow or outflow of gas from each pocket separately. Further still, the body harness and gas pockets are covered in a low density fabric which itself is covered in natural plumage that is affixed thereto. Moreover, in further embodiments, the ventral side of the outer fabric comprises strike resistant materials such as, for example, bullet proof fabric.

Yet further embodiments, the platform comprises an electronics system that provides for flight relevant data capture and display. In preferred embodiments, the electronics components are arranged into a skull cap styled helmet with an elongated frontal section that on the exterior forms the anatomical shape of a bird of the species around which the soaring platform is designed. The interior space frontal to the pilot's face houses an iPad/telephone sized display, and frontal to side ocular portals for clear “cockpit” horizon view by the pilot. In further embodiments, the electronic package includes hand touch pad key board near the gimbals for toggling through data registries visualized on the display.

In yet further embodiments, the soaring platform can accommodate the carrying of light payloads such as reconnaissance camera systems and/or light projectile weapons systems.

Other features and advantages of the invention will be apparent from the following drawings, detailed description, and appended claims.

### BRIEF DESCRIPTION OF THE DRAWINGS

The file of this patent contains at least one drawing executed in color. Copies of this patent with color drawings are provided to the Patent and Trademark Office with payment of the necessary fee.

FIG. 1 is a top view of one embodiment of the soaring platform showing relative size and placement of batten air foils. Also disclosed are areas A, B, C and D noting areas of the platform comprising dynamic parts. Also noted are particulars respecting the Primary battens.

FIG. 2 is a top view of the soaring platform as in FIG. 1 here disclosing general locations for positioning buoyancy bladders.

FIG. 3 is a drawing depicting the general nature of the folding wing.

FIGS. 4A, B, C, D, E, F, G, H, I, J, K, and L, comprise a collage of perspective views of various embodiments of the soaring platform. FIG. 4A is a top view of the platform's skeletal configuration. FIGS. 4B and C are side and top view, respectively, of the foot pedals of the rudder spar. FIGS. 4D, E, and F are from the rear looking forward on the wing (left wing depicted) and showing positioning of various dynamic and static parts. FIGS. 4G and H are depictions of typical size and shape of flight and rudder battens, respectively. FIG. 4I shows one possible strap and material placement embodiment for the front of the body harness. FIGS. 4J and K show a side view of the platform with the reciprocator box shown to be able to move in two positions, while FIG. 4L is also a side view with the reciprocator box positioned in normal flying position and further showing the nature of the helmet and compensation bladders.

FIGS. 5A, B, and C show a single tongue cam and groove system in three degrees of travel.

FIG. 6 is a close up of the back-facing side of the platform's body harness and rudder spar.

FIGS. 7A, B, and C show a close up of the reciprocator having the ability to articulate upward at its forward end (FIG. 7A) or upward at its rearward end (FIG. 7B). FIG. 7C shows the relative positioning of buoyancy compensation bladders and close up of helmet architecture.

FIGS. 8A, B and C are drawings of a top view close up of the reciprocator (FIG. 8A) and a three quarters view of one embodiment of the reciprocating mechanism (FIG. 8B). FIG. 8C is a rear facing forward close up of the rear end of one embodiment of the shuttle.

FIGS. 9A and B are drawings showing a close up of the carpal section of the wing spar and the wrist hinge (FIG. 9A) and a close up of a dual action lock key release mechanism (FIG. 9B).

FIG. 10 is a drawing showing a close up of the elbow joint between the humerus and the forearm wing spar sections.

FIG. 11 is a drawing showing a close up of the shoulder joint between the reciprocator lever arm and humerus wing spar section.

FIGS. 12A, B, C, D and E are drawings of a wing spar wherein FIGS. 12A and B are top views while FIG. 12C is from rear to forward looking into the page. FIG. 12A discloses a complete wing spar showing structural and dynamic fittings. FIG. 12B shows the various levers in the hand gimbal and spar sections. FIG. 12C shows three views of the wing sections from rear to forward. FIG. 12D shows three close up drawings of the humerus wing section. FIG. 12E is a close up of the carpal and forearm joint.

FIG. 13 is a drawing of an alternate embodiment for bringing about wing articulation of the platform in two positions of articulation and wherein the flapping is caused in-part by a S2 cam-based wing flapping mechanism wherein each outward section is urged to rotate due to cam action at the hinge wherein the cam is activated to move about an arc by cable.

FIG. 14 is a close up of one embodiment of the dynamic Primary batten fitting 41 located at the carpal spar section. The drawing depicts the batten quill inserted into a swivel mount that has an inner race that allows the quill section to rotate.

FIGS. 15A and B are close up side and top view, respectively, of the foot pedal rudder mechanism.

FIG. 16 is a close up drawing of the hand gimbal area of the humerus and related cabling.

FIG. 17 is a close up drawing of one alternate embodiment for configuration of the hand gimbal finger triggers for manipulating the Primary battens.

FIG. 18 is a drawing of the front of the body harness and some associated fabric.

FIGS. 19A, B, and C are drawings showing the helmet. FIG. 19A discloses the relative size of the helmet to the rest of the platform. FIG. 19B is a close up side view of the helmet and its hinges. FIG. 19C is a top view showing the wind screens and cockpit monitor as view from behind.

FIG. 20 is a drawing depicting opposing spar sections wherein the material, such as carbon fiber, has been molded and cut to spiral with an inward facing ridge or lip running the length of the spiral cut. It is contemplated that the opposing sections are rotated or otherwise screwed into one another with the edges of one spar sliding into tongue and groove fittings of the other, which structure provides a spiral I-beam-like inner runner extending the length of the spar and providing for exceptional tensile strength with minimal tube wall thickness and further allowing for resilience to the spar providing a means for twisting without structural failure. The rounded shapes at the ends represent disc shaped hinges wherein the hing is planar and plate shaped. The hinge axel can be placed anywhere within the disc as desired.

FIGS. 21A and B show close ups of the Primary batten two dimensional movement elements comprising the dynamic quill fittings.

FIGS. 22A, B, C and D depict in FIG. 22A a close up of a natural feather, in FIG. 22B a close up of a synthetic batten structure comprising ridges, in FIG. 22D a cross section looking along the edge of a batten wherein the top ridges and bottom ridges alternate, while in FIG. 22C the ridges and valleys align, both configurations of FIGS. 22C and D providing, in addition to the oblique angle of the ridges with respect to the central spar, variable degrees of rigidity and/or pliability to the batten stiffness.

FIGS. 23A and B depict in FIG. 23A a symmetrical batten/feather and in FIG. 23B an asymmetrical flight batten/feather.

FIGS. 24A, B, and C show one embodiment of the shuttle terminal block in down and up positions, respectively, and related positions of the lever arms. FIG. 24C shows a close-up of one configuration for the lever arm fulcrum gearing and floating axel.

FIGS. 25A and B show drawings of gear mechanisms for the shoulder joint and hand gimbal, respectively.

FIGS. 26A and B are three dimensional frontal drawings showing the relation of the wing spars relative to the pilot. FIG. 26A shows the wing spars in the resting or soaring position. FIG. 26B shows the wing spars in the dynamic or down position.

FIGS. 27A, B, and C are three quarter three dimensional view from the top of the wing spars, back plate with reciprocator and aft rudder spar as they relate to a pilot's body. In 27A the shoulder section of the humerus is designed to lead forward before turning laterally while in 27B in an alternate embodiment the shoulder section of the humerus is curved more laterally as it is directed outward. FIG. 27C shows an alternate embodiment of wing spar design wherein elements comprise rotatable carpal wing spar, wherein said rotation relative to the radius wing spar beings at a point on said radius ‘S’ where the directional angle of the radius deviates from the linear for an extension of length between 6 inches and 2 feet, before the wrist hinge.

FIG. 28 is a three dimensional rear view of one embodiment of the reciprocator mechanism.

FIGS. 29A and B are side views of one embodiment of the reciprocator mechanism. In FIG. 29A is shown a full side view of the reciprocator depicting its various parts. In FIG. 29B is shown a close up of the area labeled G in FIG. 29A showing the shuttle return spring.

FIG. 30 is a three dimensional top view of the reciprocator mechanism.

FIG. 31 is a three quarter three dimensional view of one embodiment of the reciprocator mechanism from the lower front looking through the bottom towards the top.

FIG. 32 is a three quarter three dimensional view of one embodiment of the reciprocator mechanism from the top looking forward.

FIG. 33 is a three quarter view of the fulcrum and planetary gearing in the shoulder.

FIG. 34 is a close up three quarter view of the wing spar section between the radius and carpal sections showing that the carpal can swivel about the radius section.

FIG. 35 is a three quarter close up of one example for gearing for rotating the wing as it is articulated. The gearing is at the shoulder.

FIG. 36 is a three quarter close up of the hand gimbal gearing interior of the humerus section.

FIGS. 37A and B are side views of the wing articulation in the up/soaring position (37A) and down/dynamic position (37B)

FIG. 38 is a three quarter view showing one representation of the platform with positioning and sihoulette of airfoil and rudder.

FIGS. 39A and B are three quarter drawings of a generic back plate arrangement wherein in FIG. 39A the back plate is view from the dorsal or pilot side while in FIG. 39B the same view is shown but the back plate side rails for holding the reciprocator is shown in see through view.

### DETAILED DESCRIPTION OF THE INVENTION

As those in the art will appreciate, the following description describes certain preferred embodiments of the invention in detail, and is thus only representative and does not depict the actual scope of the invention. Before describing the present invention in detail, it is understood that the invention is not limited to the particular platform arrangements, systems, and methodologies described, as these may vary. It is also to be understood that the terminology used herein is for the purpose of describing particular embodiments only, and is not intended to limit the scope of the invention defined by the appended claims.

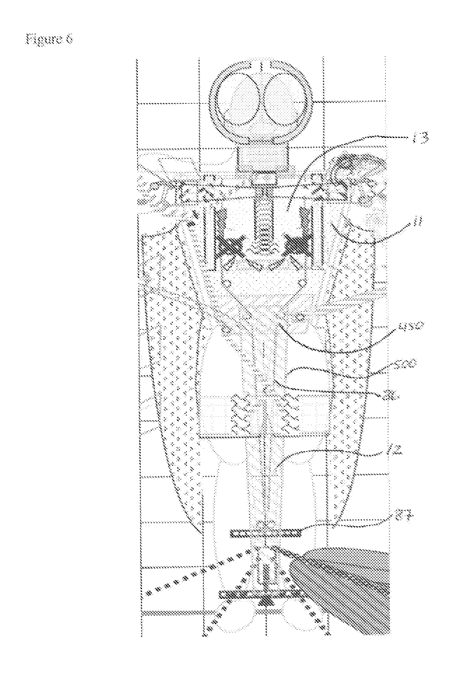

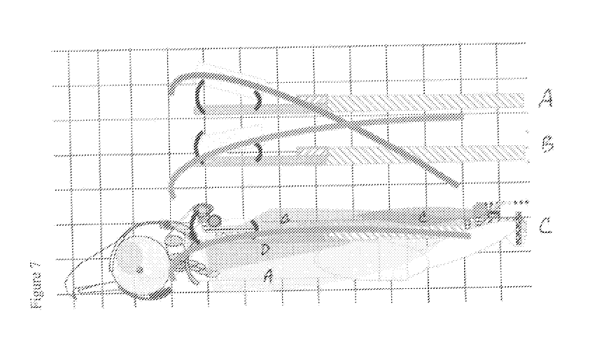

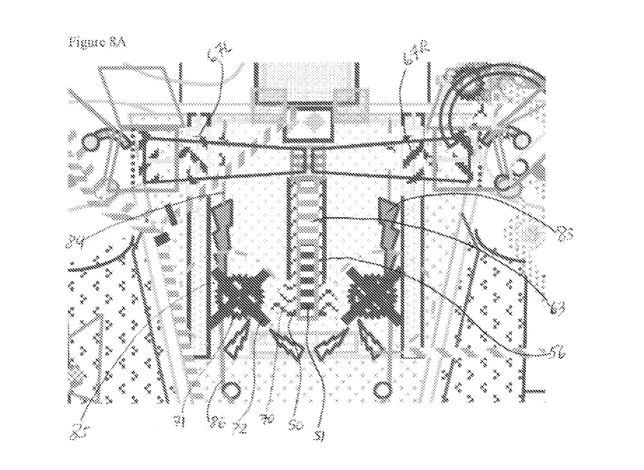

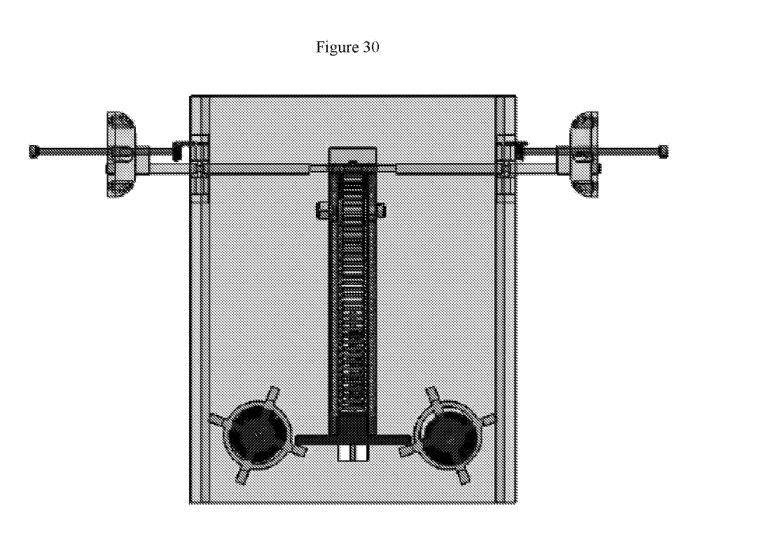

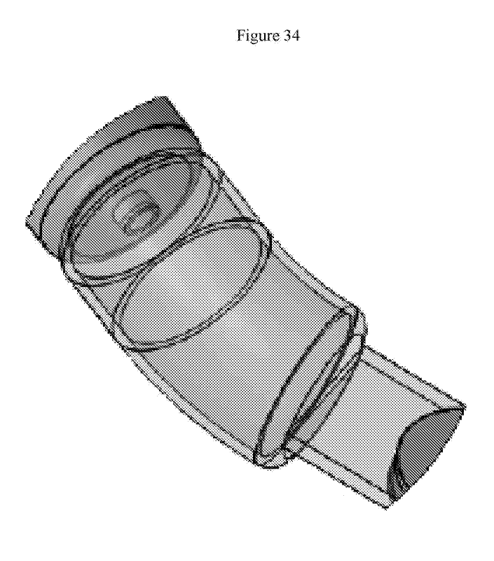

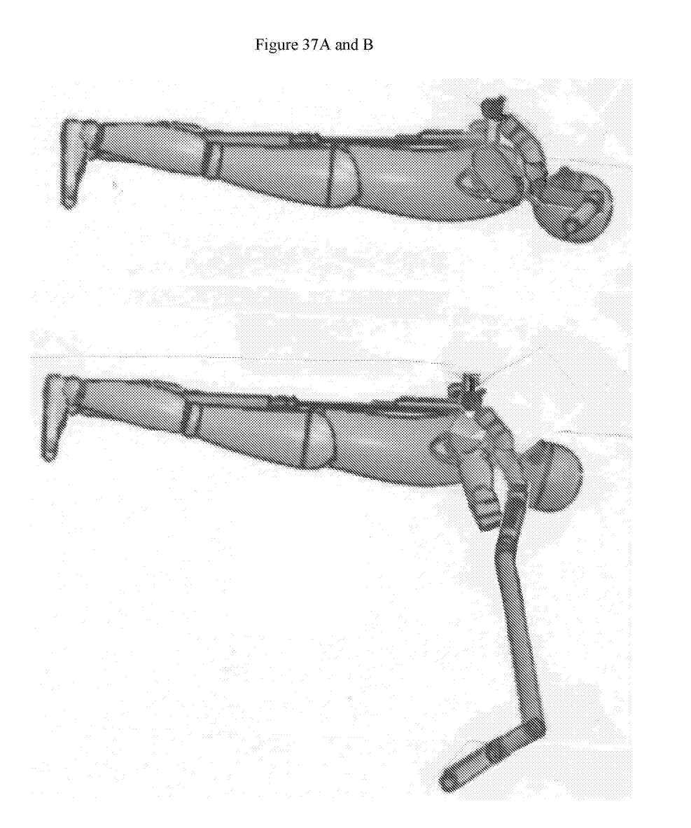

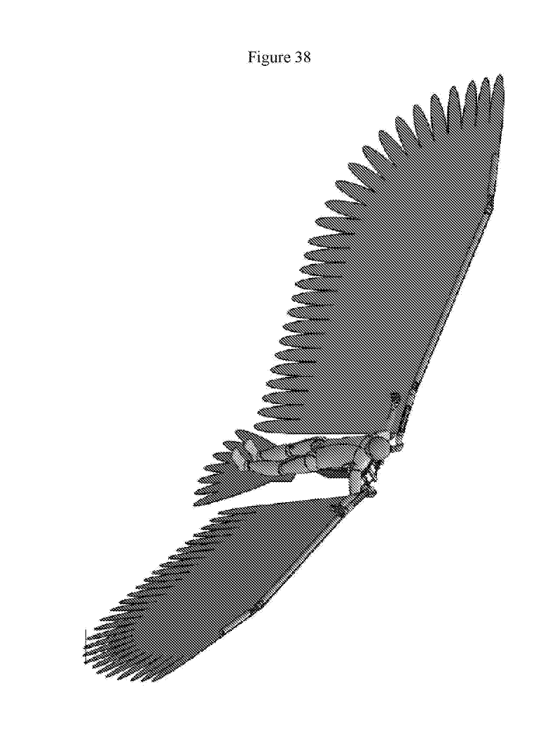

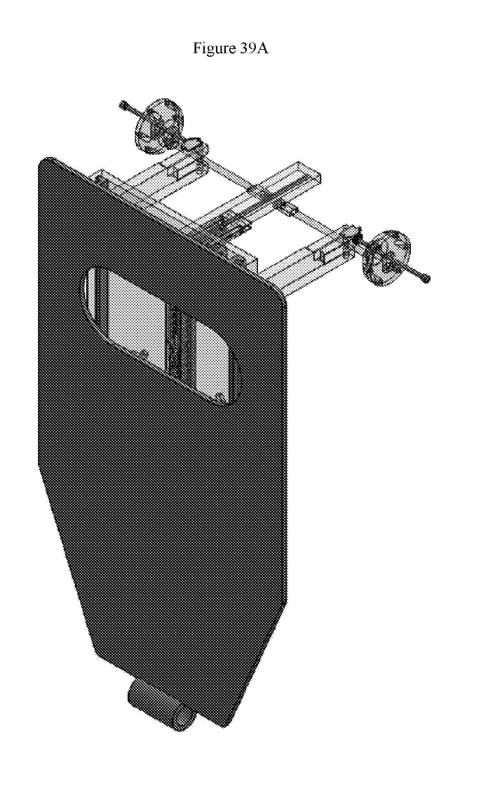

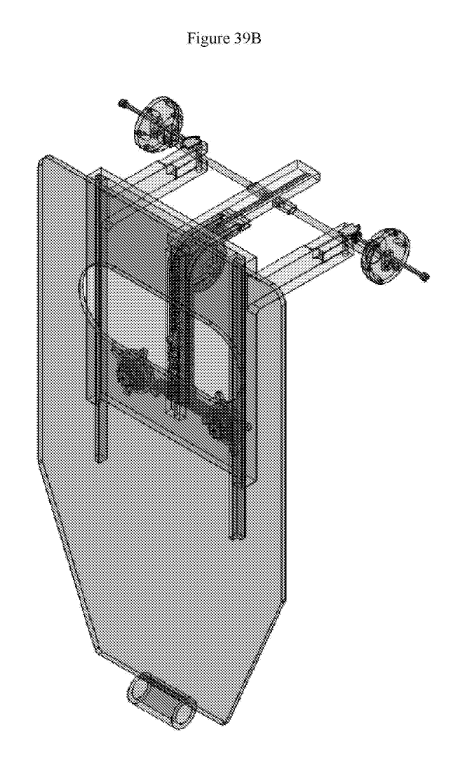

General Concept. Turning now to the articulating winged avian soaring platform, FIGS. 4A and FIG. 6 disclose one embodiment of the present invention 10 wherein the platform as a whole has multiple components including a body harness 11, foot pedal spar 12 flexibly connected to said body harness 11, a wing reciprocator 13 adjustably connected to a dorsal side of said body harness, sectioned wing spars comprising inner wing spars 14R and 14L, middle wing spars 15R and 15L, and outer wing spars 16R and 16L, hand control gimbals 17R and 17L located at a position along the inner wing spars 14R and 14L, a multiplicity of batten flight feather-like structures 18 (FIG. 4G) forming the wing airfoils (FIG. 1), a multiplicity of batten rudder feather-like structures 19 (FIG. 411) forming a rudder (FIG. 1), a means for compensating the buoyancy of the platform, an outer material for covering body and some wing components, and electronics systems for collecting and displaying flight relevant data. Where military applications are concerned the platform can further include light gathering, and IR, and FLIR camera systems and/or light projectile weaponry. More detail of the above mentioned structural component embodiments can be understood from FIGS. 26 through 38.

In a preferred embodiment, the present platform can have an overall appearance of any of several species of soaring bird including, but not limited to, for example, eagles of all species, buzzards of all species, an African nut vulture, a Turkey vulture, a California Condor, an Albatross, a frigate bird, a falcon, a hawk, a raven, a crow, a sea gull, and pelican. Generally, the soaring platform is contemplated to comprise a wing span of about between eighteen and thirty five, more typically between twenty and thirty five feet, and even more usually between 25 and 33 feet, and a wing width of about between five and seven feet. Moreover, the length of the wing spars are contemplated to span generally a length of between 15 and 27 feet. The wing and rudder battens further can comprise dimensions of about between four to six feet in length and about between eight to eighteen inches in width.

In another preferred embodiment, an aviator can pilot the soaring platform by manipulating the wings in a multiplicity of modalities including articulating the wings in a flapping motion, manipulating the wings along their leading edges with respect to the angle of attack of the leading edge with the oncoming air stream, and manipulating the shape of the wing by adjusting the shape of the wing by activating the wing hinges. The pilot can also adjust the angle of attack of the outer wing section's Primary battens with the oncoming air stream. In a further preferred embodiment, the aviator can pilot the platform in-part by manipulating the battens of the rudder which itself (the rudder) is capable of articulation in multiple degrees of adjustment including fanning, closing to narrow linear shape, split tail, up, down, fully angled from zero horizontal degrees to about as much as 70 degrees from horizontal, and swung laterally angled side to side from central alignment by up to 45 degrees. By fully angled is meant that the rudder as a whole can be rotated clockwise or counter clockwise to be angled from the horizontal. By laterally angled is meant that the rudder can be swept to either side of the midline of the platform. Thus, through the multiple modes of manipulation, the platform is capable of a high level of flight control in mimicry of avian flight modalities.

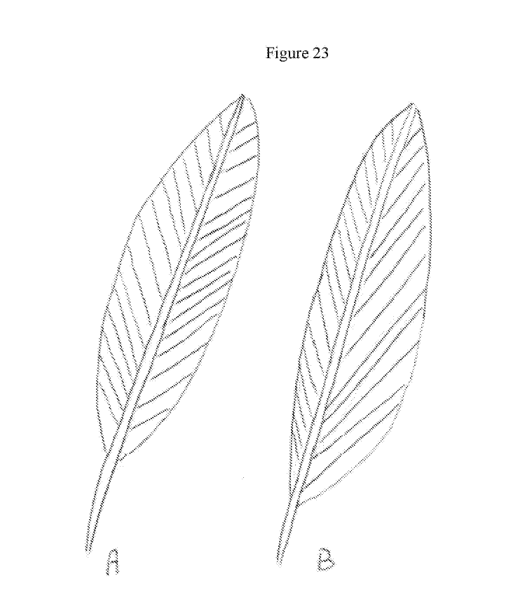

Air Foil Components. In embodiments related to the airfoil as depicted in FIGS. 4G and H, the structure of the airfoil preferably comprises feather-like battens 18 the structure of which themselves comprise a generally central spar 21 and a generally flat but shaped stiff panel 22 formed on either side of the spar. In a preferred embodiment, the airfoil material is formed into feather-like battens of dimensions appropriate for a scale ratio with that of an avian of same dimension of the same or similar species. The batten material can comprise honeycomb composite, carbon fiber, Mylar™, Polyethylene Terephthalate or the like. In an alternate embodiment, the airfoil material can comprise primarily beta keratin that has been cross-linked and crystallized. In a further related embodiment, the batten structures are textured with linear striations 23 that are molded and/or etched into the batten panel material on both a top 24 and a bottom 25 surface (FIGS. 22B, C, and D) at oblique angles to the support spar 21 that runs generally centrally the length of the batten. In alternate embodiments, said spar 21 is not formed centrally the length of the batten but instead lies distinctly laterally 26 from center the length of the batten as depicted in FIG. 23B. Battens with an off center spar generally comprise outer rudder and Primary battens which are shaped and textured to form, individually, an airfoil. Although the battens are generally linear along their length, they can be curved to an appropriate arc along the length, particularly respecting battens placed along the humerus, radius and inside portion of the wing spar segments. This attribute provides for the necessary air foil shape of the wing itself.

In embodiments where the batten structures are formed comprising composite materials, a CO2 laser can be used to etch striations across the batten surface. In the alternative, the striations can be made by fine detail of a molding process. For example, with respect to carbon fiber shaping, the carbon fiber sheet material can be compressed between two halves of a mold designed to be shaped in the form of a feather allowing for the sheet material to have pressed therein indentations forming the striations in the sheet material. Formation in this manner allows for the fibers within the sheet material to keep their integrity and strength. It is contemplated that the striated patterning of the battens will provide a structurally significant strengthening quality to the batten structure, and will also provide a benefit through aiding the shedding of air past and from the surf of the wing as a whole. Further still the grooved-like composition allows for wetting agents, such as preening oil or otherwise possessing a slippery water and air-shedding quality, to better adhere to the surface thereof. For example, in one embodiment, it is contemplated that the batten material can be rubbed with a ten percent solution of dimethyl silane, and make the battens slicker for extended time periods with respect to air stream slippage.

With respect to further structure of the battens, in a preferred embodiment the etching or molding of the batten forms rippled-like structure to the material making up the batten panel. Each ripple of the panel leading out from the spar is defined by ridges in between etched out or molded material (i.e., the ridges are what is left after etching or what is in between the striation depressions from molding. As depicted in FIGS. 22C and D, the molded or laser etched striations can be either staggered as between the ridges formed on the upper surface and the ridges formed on the bottom of the batten panel (FIG. 22C), or aligned as in FIG. 22D. These attributes allow varying degrees of rigidity or pliability to the batten structure.

Generally, it is contemplated that the battens can be scaled at between five to six feet in length and eight to eighteen inches in width. It is further contemplated that the batten spars 21 run the length of the battens and comprises a mixed cylindrical 27 and I-beam 28 construction (FIG. 22B) from a proximal end 29 to a distal end 30 of said spar 21, respectively (FIG. 4G). The spar 21 at the proximal end 29 has a length without batten material. This portion forms a cylindrical and conical quill-like shape for use in connecting the batten to the wing spars. In alternate embodiments, the battenless portion can be ovoid as opposed to circular in diameter which shape can provide for resistance to bending or otherwise structural failure from lateral force. The battens material portions of the feather construct are contemplated to possess a thickness of about between 2/16 the of an inch to ⅛ th inch. Other dimensions are also useful both thinner and thicker. Generally, the battens are contemplated to mimic the shape of natural flight feathers with the spar size to batten size ratio maintaining the ratio of natural feather structure as one skilled in the art will understand.

In another embodiment, referring to FIG. 1, the batten configuration along the length of right and left wing spars comprises a set range of number of battens comprising between one and five Tertiary battens 31 per right and left wing that are placed along the inner most length of the wing spar (area nearest the body), between four and ten Secondary battens 32 that are placed along the middle length of each left and right wing, and between four and ten Primary battens 33 that are placed along the outer lengths of the right and left wings. As between the left and right wing battens, they are mirror images of one another. FIG. 1 depicts one embodiment wherein there are 4 tertiary, 8 secondary and 8 primary battens.

The rudder battens can be between two and ten in number equally divided between a left and right rudder batten set. As between the left and right sets, they are mirror images of one another. FIG. 1 depicts one embodiment wherein there are a total of 8 battens equally divided between four left and four right batten sets.

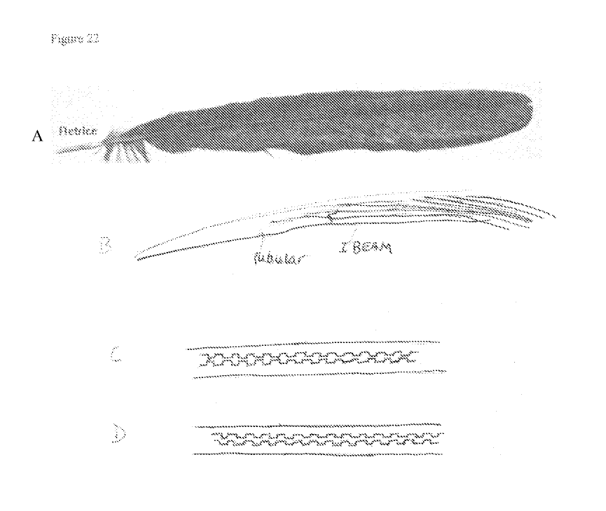

As depicted in FIG. 21, the battens are semi-permanently attached to the wing spars by insertion of the quill-like proximal end 29 of the batten spar 21 into a releaseable female fitting 34 within orifices 35 in the trailing edge 36 of the wing spar 21 (see FIG. 14 for one example). There are numerous specific methods that can be used for semi-permanent attachment of the battens as would be understood by one of skill in the arts. In one embodiment, the quill-like spar portion proximal end 29 is fitted with an end cap 37 designed to releasably slide into the female fitting 34 and snap into a locked position. For example, the releasable slide can function in a fashion similar to telephone cord jacks wherein a locking tab 38 snaps into place as the proximal end 29 is seated into its female receptacle 34. The fittings can be separated by pressing on the tab 38 to release the locking component (FIG. 21). Other means of attachment can be used as would be understandably by one of skill in the arts.

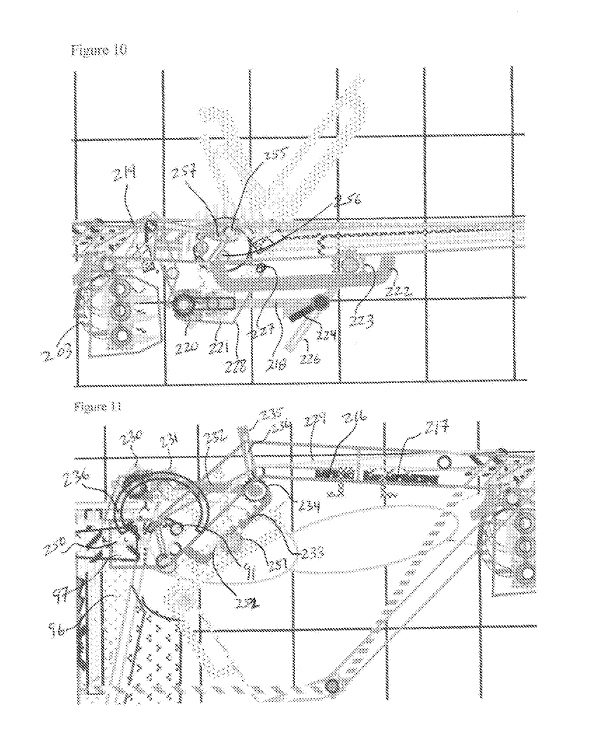

In a further related embodiment, the Primary battens are specifically attached to the outer wing spar such that they can be urged to rotate in their respective quill sockets clockwise and counterclockwise. The Primary battens are allowed to rotate due to the manner in which the female receptacle 34 is attached to the wing spar. Specifically, as depicted in FIGS. 9A and 14 the outer wing spar 40 comprises, among other elements, dynamic quill fittings 41 that possess two directions of vector movement, namely a rotational vector and an angular vector. With respect to the rotational vector movement, when a Primary batten proximal end 29 end cap 37 is fitted into said female receptacle 34, the receptacle 34 comprises the center of the dynamic fitting 41 which center portion is capable of rotating within the dynamic quill fitting 41. In preferred embodiments, the plane of the Primary batten panel is defaulted to lie on a parallel positioning with respect to the plane formed by the length of the wing spar 40. The batten dynamic quill fitting 41 will allow the batten to rotate in both a clockwise and counterclockwise motion causing the batten panel to move out of the parallel plane with respect to the wing spar 40. Thus, by such rotation the leading edge of the batten can be adjusted with respect to the angle of attack of oncoming airflow. Further still, the portion of the dynamic quill fitting 41 comprising the female receptacle 34 that allows for the rotational vector further comprises a Primary batten rotation tab 42 that rotates with that portion of the fitting and can be used as a lever arm to action the rotational vector. In other words, when the batten spar quill-like proximal end 29 is inserted into the rotational vector component of the dynamic quill fitting 41, the end cap 37 fixes the batten securely to the fitting 41 and will be able to be made to rotate by manipulating the rotation tab 42. As will be disclosed below, the rotation tabs are manipulated by cable leading to the hand gimbals and springs which keep the batten orientation in default positions. As will be understood by one of skill in the art, in an alternate embodiment the default and active poisitions of the primary battens can be electrically controlled such as by use of servos and wiring from the hand gimbal which in turn can possess electronic sensor elements to the communicate with the servos.

With respect to the angular vector movement, the batten and its central spar can be initially inserted into the dynamic quill fitting such that the batten lies 90 degrees with respect to the wing spar 40 length. However, the dynamic quill fitting 41 will allow the batten to swing out of a 90 degree position such that the batten along its length can achieve a nearly parallel relation with the length of the wing spar 40. For example, as shown in FIG. 1, each succeeding Primary batten from interior to exterior of the outer wing spar is angled at greater and greater degrees from 90 degrees with respect to the carpal wing spar 40. The degree of angle any given Primary batten is set in the wing spar depends upon the avian species upon which the specific platform is based so as to maintain appropriate natural form and proportionality for purposes of biomimicry.

In further embodiments, the Primary battens and the outer fanning rudder battens are shaped so as to form, individually, airfoils so that they have an innate ability to provide for lift with oncoming airstream. Preferably, the airfoil shape and relative dimension are based on the shape and dimension of the same positioned feathers of the avian species upon which the platform is configured.

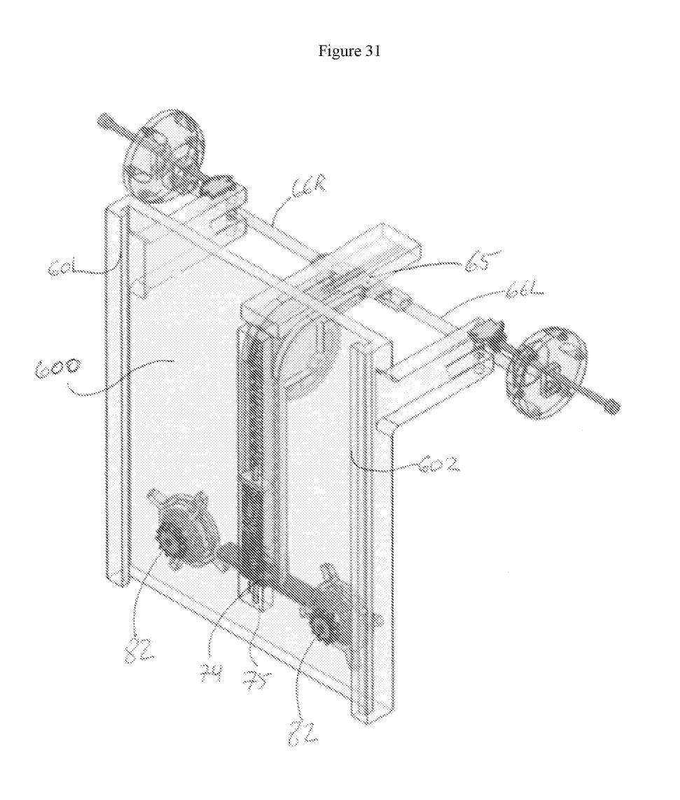

Reciprocator. A primary aspect of the current soaring platform is the ability for the platform to swing or articulate its wings like unto a bird. The current invention contemplates numerous device configurations to bring about wing articulation through a primary mechanism which operates based on the principle of a reciprocating ‘engine,’ namely a device that has the ability to oscillate back and forth and in the process drive the wings back and forth in an up and down motion, generally. In one such reciprocating configuration, wing articulation is brought about by a reciprocator apparatus adjustably affixed to the dorsal side of the body harness. By adjustably affixed is meant that the reciprocator unit is attached to the harness so that it can be urged to move such as, for example, by sliding on at least one but preferably two slide rails forward or rearward along the dorsal surface of the body harness back plate (FIGS. 39A and B). The slide rails as such allow the reciprocator as a whole unit move to any desired position within a given range allowable by the size of the harness back plate. Further, the reciprocator can be locked into position on the slide rail by numerous means as are well understood in the arts such as locking pins, set screws, clamps and the like. By forward or rearward is meant that forward is toward the pilot's head and rearward is toward the pilot's feet. In one embodiment, the ability to adjust the position of the reciprocator on the back plate can be accomplished in-flight by use of an electric motor and screw drive positioned within the reciprocator housing and electronically connected control buttons located on a touch pad adjacent the left or right hand gimbals. FIGS. 28 and 31 depict one example of the reciprocator frame 600 that supports lateral slide rail catch runners 601 and 602 which slidably maintain the reciprocator to the back plate slide rails 599 (FIG. 39)

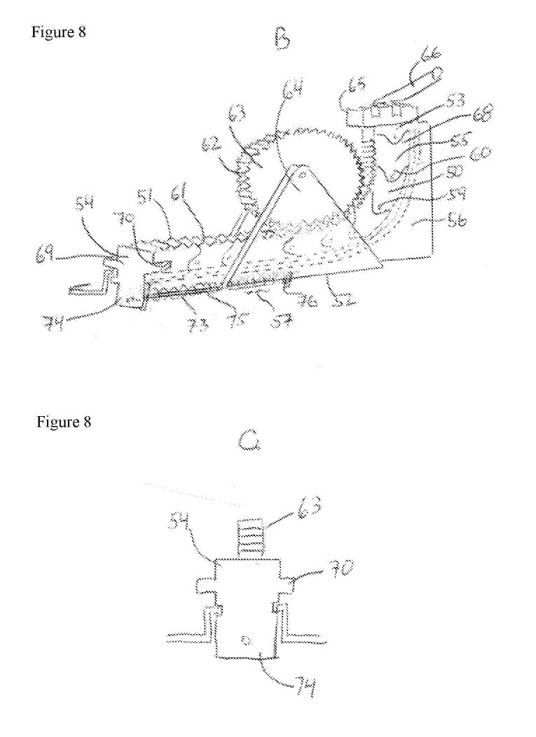

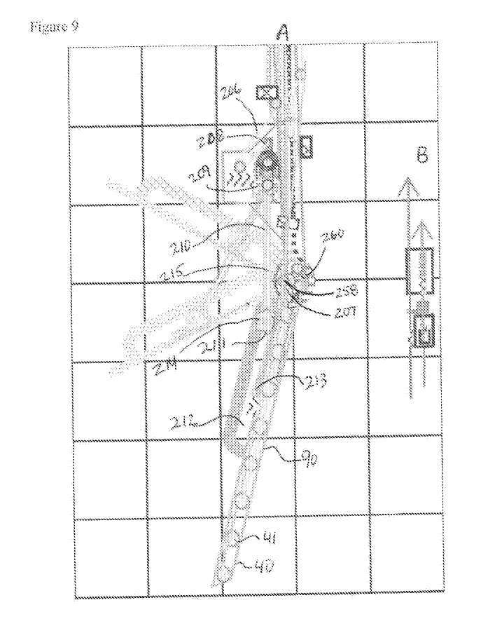

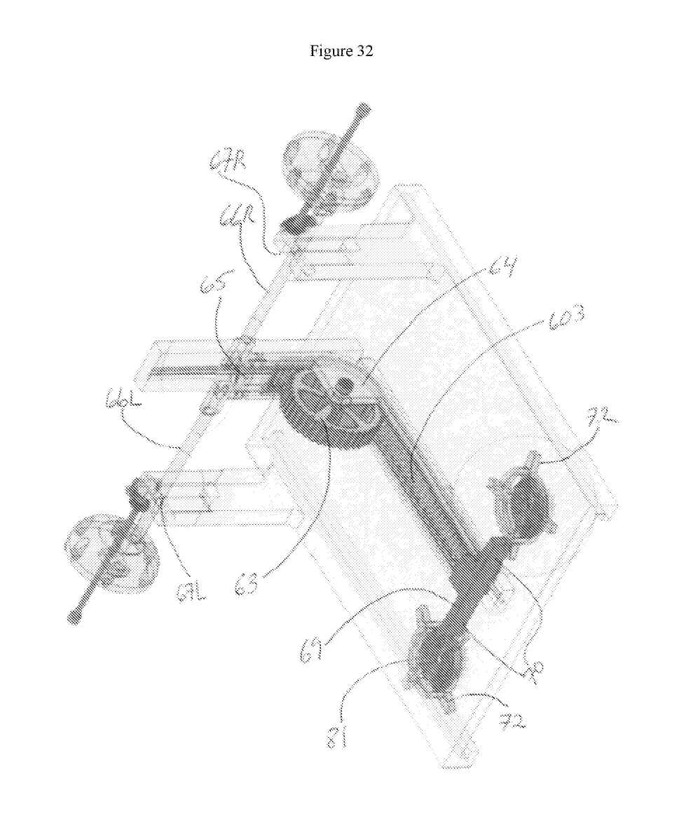

As depicted in FIGS. 6 and 8, and more clearly in FIGS. 29A and FIG. 32, the reciprocator comprises generally a means for translating a force directed in one plane A, specifically a plane parallel with the pilot's body or more clearly a plane parallel to a plane formed by the pilot's shoulders and buttocks, to a force directed in a second plane B that lies up to 90 degrees out of plane A. It is contemplated that the second plane B in which the vector force is directed is dorsally away from the body. Such altered vector of force is brought about by a shuttle 50 such as a segmented block shuttle as depicted in FIGS. 8A and B. An alternative shuttle arrangement can comprise a shuttle designed as a chain drive 603 as depicted in FIGS. 29B and 32. With respect to a shuttle designed as a segmented block as in FIG. 8B, the shuttle 50 has a dorsal side 51, an opposing ventral side 52, two lateral sides, left and right, a forward end 53 and a rearward end 54. The shuttle can be made of light weight composite, plastic, metal, or combinations thereof, and comprises a multi-component block chain 55 that is configured to slidably move on a guide rail structure 56 that has a straight portion 57 and a portion forming an arc 58 followed by a second straight portion lying in plane B. By block chain is meant that the shuttle is formed from a block of material that is segmented into a multiplicity of individual links that are moveably connected to one another. In particularly preferred embodiments, the segments are specially mated such that each segment abuts the next positioned segment in the chain so as to allow the segments to apply pressure against the next segment without buckling or locking up. The links of each segment are connected together in fashion similar to that of a regular chain or, alternatively, a pin 59 and hinge nipple 60. In one embodiment, the forward and rearward ends of each segment can be curved surfaces. In alternate embodiments the front and rearward ends of each segment can be in the form of a tongue and groove. The nature of the curved or tongue and groove form allows not only for the chain links to be connected, such as by pin, but also for translating force continually against one another along the entire length of travel of the shuttle regardless of the direction of vector force (forward, rearward and/or vectored out of plane A to plane B and back) applied by one segment against the next, and further for allowing the shuttle as a unit to travel along the guide rail structure 56 from straight to a curved or arc displacement from the linear. Preferably, the straight portion 57 lies rearward to the arc portion 58. Further still, the shuttle as a whole is configured to slide along the guide rail by low friction modalities such as a multiplicity of roller bearings placed either in slots running the length of the rail slide or integral with the shuttle links.

Further describing the segmented block chain shuttle as depicted in FIG. 8B, along at least a portion of length of the shuttle's 50 dorsal side 51 from the forward end 53 towards the rearward end 54 is configured a multiplicity of gear-like teeth 61, integrated therewith, such as by molding or milling depending upon the composition of the material used (FIG. 8B). In preferred embodiments, each segment of the shuttle has a multiplicity of such individual gear teeth 61 and the positioning of the teeth on each segment is configured to begin and end in a full, as opposed to a partial, gear tooth. The gear-like teeth 61 are configured to fit or mate with gear teeth 62 of a gear wheel 63 which is positioned dorsally to the shuttle such that as the shuttle travels along the guide rail 56, the shuttle teeth 61 mesh with the teeth 62 of the gear wheel 63. The gear wheel 63 is fixed into position dorsally to the shuttle by gear wheel axel support posts 64. The positioning of the gear wheel additionally stabilizes the shuttle as it slides along the guide rail 56 and out of the fore and aft plane and into the arc portion of the guide rail.

Continuing with FIG. 8B, with respect to the guide rail portion that forms an arc 58, this portion terminates forward of the gear wheel 63 and becomes linear to a height out of plane A and into plane B to about the diameter of the gear wheel. The guide rail at the forward termination comprises a termination block 65 that keeps the shuttle from traveling out of the slide at the forward end of the guide rail slide. Thus, in operation, the shuttle 50 can slide fore and aft in the guide rail 56 and, as it moves forward through the arc portion 58, it is essentially sandwiched between the guide rail 56 and the gear wheel 63. The forward end of the shuttle 53 comprises a terminal block/link 65 that further comprises a dynamic fitting for moveably attaching left and right reciprocator leverage arms 66L and 66R, respectively. The fitting between the leverage arms and the terminal link 65 allows for the terminal link to move in the plane B vector as it, with the balance of the shuttle, moves back and forth in the guide rail 56 while at the same time allowing for the leverage arms to make a see-saw motion with laterally placed fulcrums 67L and 67R on each of the left and right sides of the reciprocator housing. As one of skill in the art will appreciate, since the left and right fulcrums 67L and 67R are fixed in their respective positions on the reciprocator housing 600, as the lever arms move up and down, or ventrally and dorsally, the ends of the lever arms intended to be connected to the terminal link 65 will swing in an arc, such that the fulcrum equates to the arc's center of radius. Because the ends of the lever arms swing in an arc, as the terminal link moves ventrally or down, as the lever arms follow, they move away or laterally from the downward moving terminal link 65 as well. Thus, the terminal link-lever arm attachment is configured to allow the lever arms to slip laterally within the movable attachment. Further still, it will be appreciated that since the lever arm arc movement is a movement in a linear up and down vector, the terminal link 65 and shuttle will have a limited range of linear movement within the guide rail such that the forward end of the shuttle with its terminal link 65 will only move in a range within the arc section of the guide rail and within the vertical linear portion 68 of the guide rail as it bends out of the arc section towards its forward terminus The range of movement can also be visualized by the range of rotation of the gear wheel 63. In preferred embodiments, where the gear wheel circumference matches the arc circumference of the guide rail, the range of gear wheel rotation is generally between a quarter and one half rotation. In particularly preferred embodiments, the degree to which the wings are articulated up and down depends upon the position of the lever arm fulcrums on the sides of the reciprocator housing relative to the length of travel of the terminal link 65 in plane B. Generally, the length of travel will be to a position dorsally in the plane B forward linear part of the slide rail and farther out from plane A than the distance out of plane A that the reciprocator housing sides holding the fulcrums are constructed, i.e., that comprise the lever arms 66L and 66R fulcrums 67L and 67R.

In further aspects, the shuttle comprises a power drive link 69 at the rearward end 54 of the shuttle 50 that travels only along a portion of the guide rail in plane A and is configured with power drive wings 70 on either side of the link which are used for forcing the shuttle within the guide rail wherein the means for forcing comprises spring loaded drive gears 71A and 71B positioned laterally on either side of the shuttle 50 and guide rail 56, respectively. As one of skill in the arts will comprehend, the spring loaded gears work in a similar fashion to a wind up alarm clock mechanism wherein with the present invention the spring provides potential energy for repeated wing beat motion. The spring loaded gears comprise spaced drive arms 72 that will contact the drive wings 70 on the power drive link 69. As the gears rotate under spring power, the gear drive arms 72 cycle, engaging the drive wings 70 on either side of the power drive link 69 simultaneously urging the shuttle forward. As the drive arms 72 swing forward they cycle through an arc movement to engage the shuttle power drive link 69 and continue applying spring-powered torque force thereon through a distance of movement wherein the terminal link 65 of the shuttle 50 travels from its lowest point to its highest position which translates with respect to the leverage arms 66L and 66R a wing movement from a soaring resting position to a swept down position. When the terminal link 65 reaches its highest point, the drive arms 72 slip past the drive wings 70 and the shuttle is free to slide within the guide rail 56 without the drive arms hindering the shuttle's movement.

In further embodiments, when the drive arms 72 have finished engagement with the drive wings 70 of the power drive link 69, rather than simple freedom of movement, the shuttle 50 is urged to return rearward in the guide rail 56 by a reset spring 73. The resent spring 73 is configured to lie on the ventral side 52 of the shuttle 50 and runs parallel to the guide rail 56. The reset spring 73 is held in position by a ventral spring tang 74 formed at the rearward terminus of the power drive link 69. Leading forward from the tang 74 is a spring guide rod 75. The guide rod 75 at its forward end runs through an orifice 76 that is positioned on a tang 77 connected with the guide rail structure. The tang 77 acts to keep the reset spring 73 in place, the spring being positioned so as to surround the spring guide rod 75. As will be understood by one of skill in the art, as the shuttle 50 is urged forward by the left and right spring-powered drive arms 72, the single reset spring 73 is compressed. As the drive arms 72 slip out of engagement with the drive wings 70, the compressed reset spring 73, along with the naturally rising wings from both angle of oncoming air attack and the effects of the wings air foil, forces the shuttle 50 rearward. When the shuttle 50 reaches the end of its rearward travel, spring tang 74 trips a toggle 78 (not specifically indicated but well understood by one of skill in the mechanical arts), urging it to move out of the way and which allows both left and right drive arms 72 to advance in their respective rotations to contact the drive wings 70 of the shuttle power drive link 69. The drive arms 72 of the drive gears 71L and 71R will not, however, proceed to cycle unless the left and right coil spring actuators 79 (also not specifically indicated but well understood by one of skill in the mechanical arts) have been triggered at the hand gimbals, which trigger displaces gear locks 80 (also not specifically indicated but well understood by one of skill in the mechanical arts) within the coil spring actuators allowing the drive gear 71 and drive arms 72 to rotate. It is contemplated that the drive gears 71 will continuously rotate and engage the drive link to urge the shuttle forward causing the wings to articulate as long as the gimbal trigger is activated. Further, as one of skill in the mechanical arts will readily understand, the length of stroke of each cycle can be preset to cause a range of articulation between small and large wing beats. Additional embodiments contemplate alternate mechanical configurations for the operation of the reciprocator. For example, in one alternate embodiment, the as the shuttle is leveraged forward by the drive gear arms, no pressure is applied in reverse by the reset spring until the shuttle has nearly reached it maximal forward position at which point, a lever is activated and a cam forces the spring rearward riding against the tab 74. Other embodiments include additional third and fourth coil spring/drive gear units that can be stacked above the above-described left and right power drive gear units to provide additional torque for powering the drive wings 70 of the shuttle rear terminal block, and can apply reciprocating power further by drive bars to be located on either side of and connected directly to the wheel 63 and directed towards said third and fourth drive units for engagement with their drive arms for said added wing swing force.

Coil spring/drive gear units (also referred to as actuators) comprise a multiplicity of working components, namely, a windable coil spring 81, drive gear 71 connected to the coil spring 81, gear lock 80, and a ratchet gear 82 for winding the coil spring 81. To wind the spring via the ratchet gear 82, the reciprocator further comprises an elongate ratchet arm 83 (FIG. 8A) that engages the ratchet gear 82. The ratchet arm 83 comprises a forward end 84 and a rearward end 85 (not specifically indicated). At the forward end 84 is attached a keeper spring 86 that maintains the ratchet arm 83 towards a forward idle position. The rearward end 85 has connected thereto a cable 86 that is directed rearward out of the reciprocator and into the pedal spar 100 (FIG. 6) where the cable terminates, it being connected to a foot lever 87 that extends out of the spar such that the pilot can engage the foot lever 87 with either the left or right foot. In operation, the pilot can use leg muscle power to ‘pump’ the foot lever 87 by pressing rearward on it causing the cables 86 leading to the ratchet arms 83 (one on each side of the reciprocator engaging the ratchet gears 82 on both left and right coil springs 81). Alternate coil spring winding mechanisms are also contemplated such as a foot pump pedal that works a lever arm that in turn ratchets the coil spring as one of skill in the mechanical arts will readily comprehend. In operation, the pilot will have the leverage usage of the legs and feet to rewind the coil spring in that as the legs are pushed rearward, the manner of attachment of the body harness will allow for anchoring force against the pilot's shoulders.

Alternate embodiments of the reciprocator are disclosed in FIGS. 28 through 32. As visually disclosed, the shuttle can comprise a chain drive 603 configured as a typical bicycle, though modified, chain that is channeled via a shuttle guide as with the prior described segmented block shuttle. The chain shuttle can engage the guide wheel 63 in the same fashion and connect to a rear 69 and forward 65 terminal blocks.

Further attributes of the reciprocator include the ability for the whole reciprocator and housing to alter its orientation with respect to the plane of the back plate. In preferred embodiments, both the rear facing side and the forward facing sides of the reciprocator box can swing into plane B. As shown in FIGS. 7A, 8, and C, the normal flying orientation of the reciprocator is parallel with the back plate as depicted in FIG. 7C. However, in a particularly preferred embodiment, when the aviator is contemplating a landing maneuver, the pilot can trip a toggle 400 at the left or right hand gimbal, such as optimally by use of a thumb activate lever, and cause either the rear facing end of the reciprocator box to pop out under spring loaded pressure, and/or trip a second toggle 401 also located adjacent the hand gimbal causing the forward facing end of the reciprocator box to pop out into plane B. It is to be understood that the degree of swing allowed at the forward side of the reciprocator is a greater arc than the rear facing swing capability. This greater swing for the forward end is contemplated to assist in allowing the wings as a whole to be swept upward to assist breaking or slowing down for landing, for example. Since the reciprocator is slidably attached to guide rails as earlier stated, the ability of the reciprocator unit to swing into plane B from either its forward or rearward ends is brought about by the back plate being constructed such that the reciprocator box so attached to the guide rails are together “floating” in the framing of the back plate. The means for such floating construct can include releasable locking mechanisms as one of skill in the mechanical arts will appreciate in association with lateral arc shaped forward 625 and rearward 626 riders (FIGS. 7A and B) that connect to the lateral forward and rearward sections of the reciprocator/guide rail containing unit.

Having described typical embodiments of the reciprocator, additional features and capabilities can be further included in addition or in the alternate. For example, S2 cams can be incorporated into the terminal link 65/lever arm 66 hinge such that as the shuttle approaches its terminal forward position within the guide rail, leverage is applied to either an S2t or S2v cam which causes cam vector force to act in rotating the lever arm up or down (or alternatively envisioned to cause pulling of the shuttle forward in the guide rail). Thus, by such modality the present platform can use S2 cam technology to assist increasing substantial force and stability to wing beating movements expected for dynamic elements of the current platform.

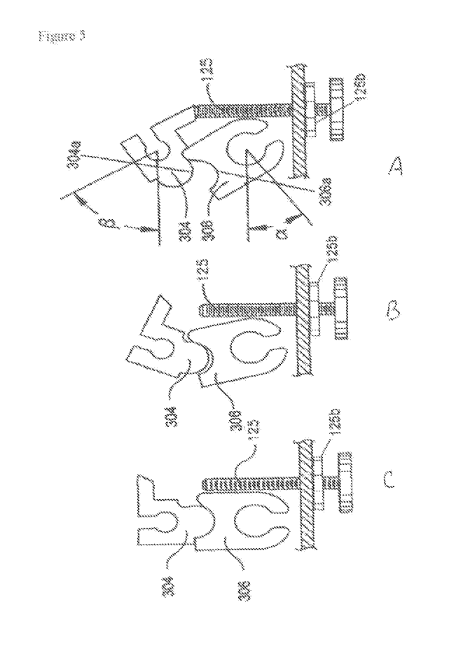

Wing Spar Configuration. The wing struts are based on an avian skeletal template, meaning that for any soaring bird species chosen on which to base a platform of the current invention, the wing struts or spars are designed to the same relative size ratios of that avian's wing bone anatomy. Specifically, as depicted in FIGS. 1, 3, 4 and 12B, the struts comprise three sections analogous to the upper arm (humerus) 88, forearm (ulna/radius) 89, and hand (carpal) 90. Each section is connected by hinge structures that allow the wing to be collapsed or folded in a fashion similar to that of an avian wing (FIG. 3). Thus, there are three articulable hinges per left and right wing, namely, a shoulder hinge 91 between the reciprocator lever arm 66 outside the reciprocator fulcrum 67 and the humerus 88, an elbow hinge 92 between the humerus 88 and forearm 89, and a wrist hinge 93 between the forearm 89 and carpal 90. The shoulder 91, elbow 92 and wrist 93 hinges are lockable automatically when unfolded wherein the locking mechanism of the hinge can comprise spring loaded keys which can be urged out of a locking position when it is desired to collapse the wing as further disclosed below as is easily understood by one of skill in the mechanical arts.

The wing spar sections can be formed from a variety of structures as one in the structural arts will appreciate including I-beam, tubular, and/or shaped to provide an airfoil leading edge curvature. In one alternate embodiment the spar sections can be shaped spun carbon fiber to mimic the bone structure of the desired avian. Alternatively, the spar sections can have configured exterior to the spar structure itself shaped material such as Styrofoam, plastic, composite, or even cross-linked and crystallized beta keratin-based material formed to mimic that portion of the wing of the leading edge of the specific avian wing upon which the platform is modeled. It will be understood by one of skill in the aeronautic arts that the leading edge shaped structure acts to provide lift by the dividing of air flow over the top and under the leading edge. It will also be understood that the leading edge will be covered in an outer ‘skin’ fabric configured to mimic bird anatomy, such as for example, natural plumage affixed on or formed into the fabric. The fabric itself can comprise any useful material of low density construction.

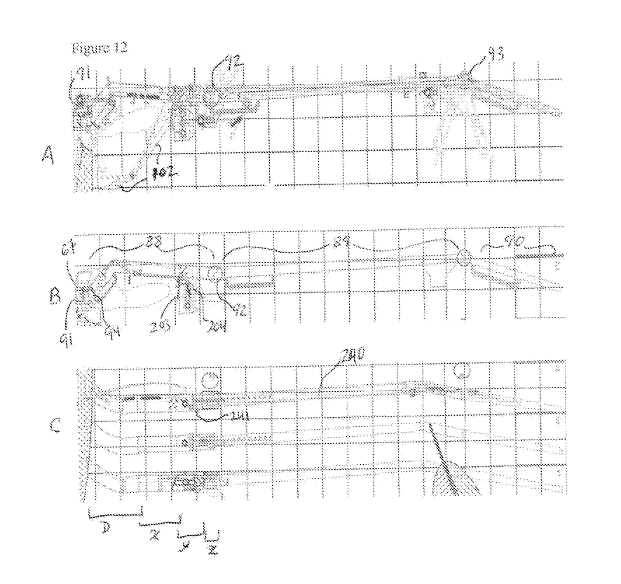

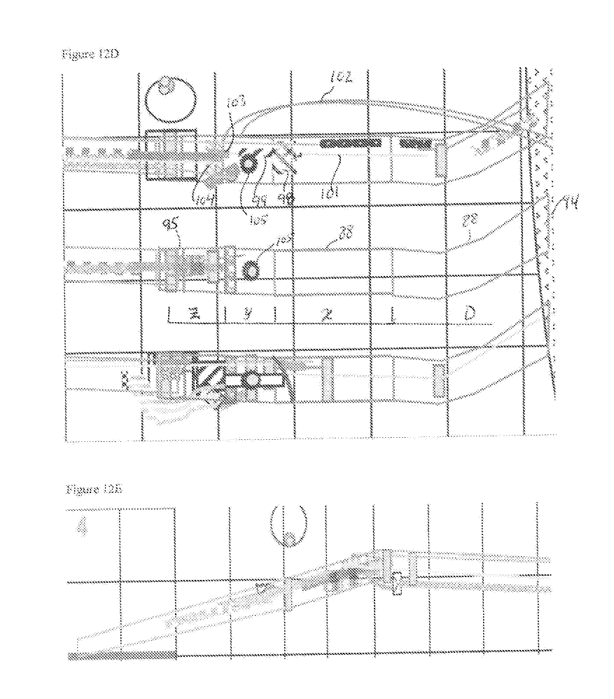

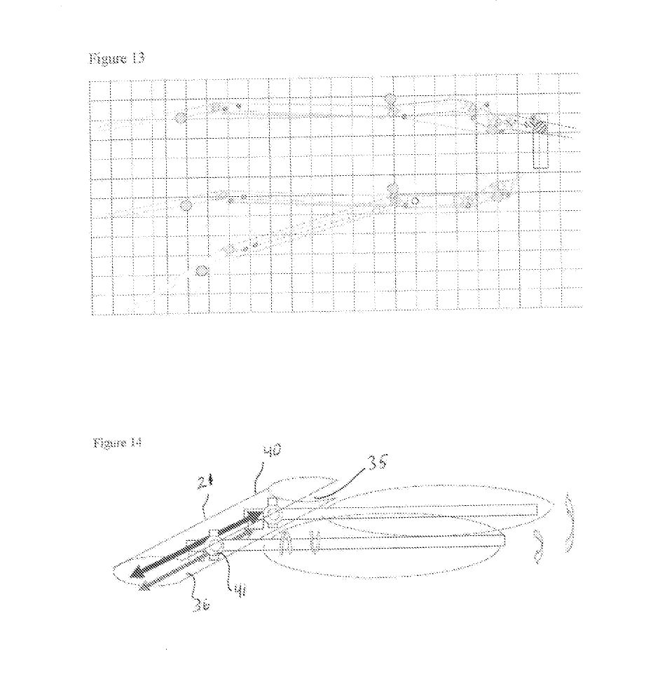

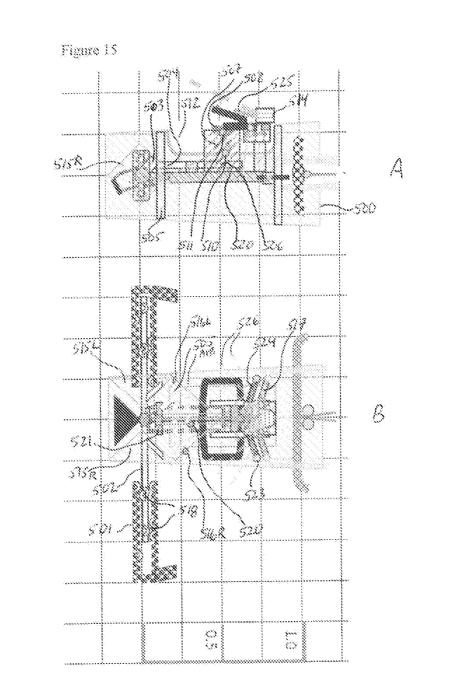

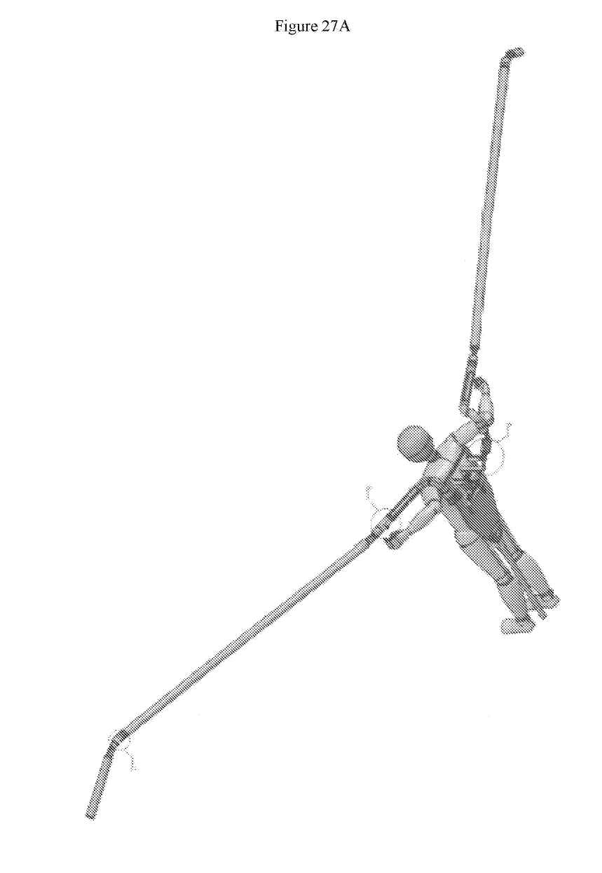

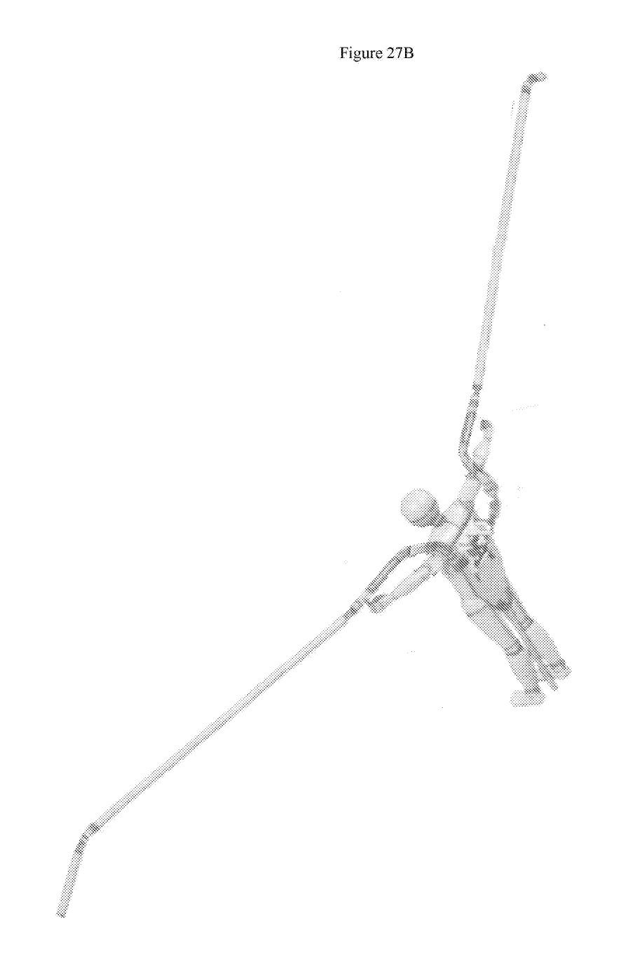

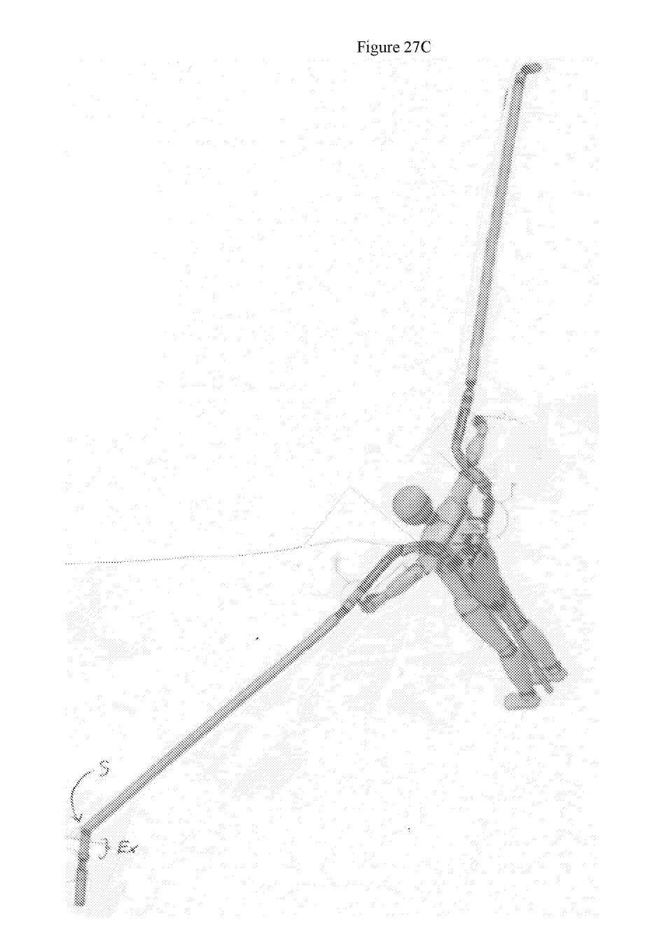

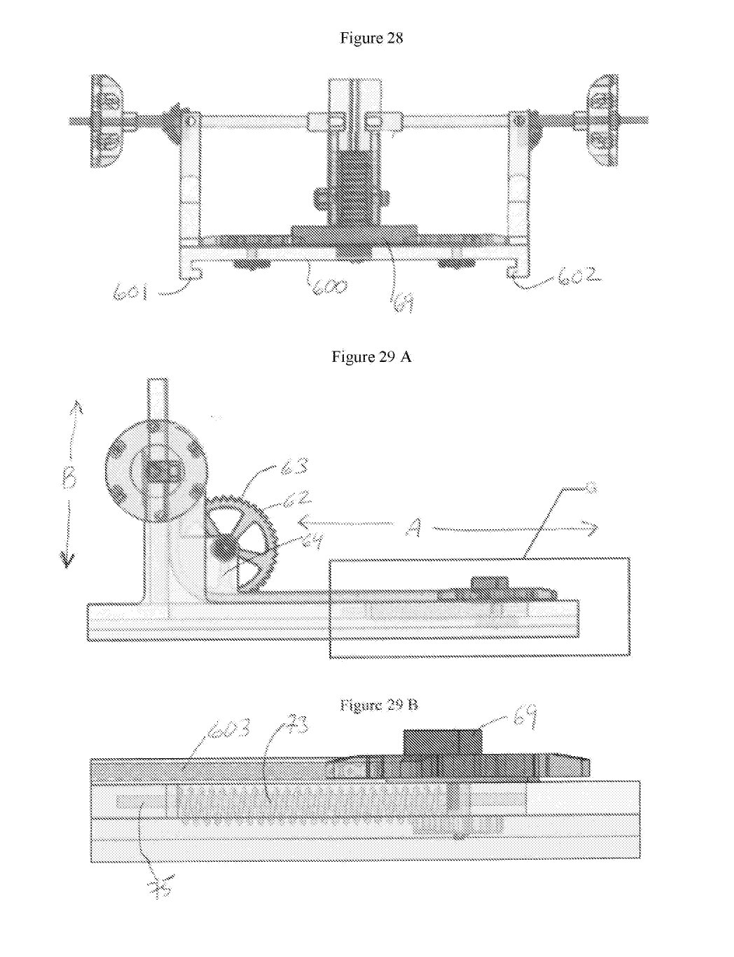

Wing sections. Humerus. Referencing FIGS. 12B and 12D, the upper arm section or humerus 88 has proximal 94 and distal 95 termini The proximal end 94 terminates at the shoulder hinge 91 while the distal end 95 terminates at the elbow hinge 92. Typically, the humerus 88 will have a shorter length than the radius 89. Depending upon the avian species, the humerus can be longer or shorter than the carpal 90. Generally, the distance of the distal end 95 laterally from the outside of the reciprocator fulcrum 67 is about 2 to 3 feet. However, the shape of the humerus along its length departs from an avian humerus in that it is curved for a distance along its length from the shoulder/fulcrum bending towards the head ward direction (length X) then forward, curving over the shoulders of the pilot (FIG. 12C, length X from rear view, FIG. 27A), followed by curving laterally outward from the body of the craft (length Y). This curvature is further depicted, for example, in FIGS. 26 and 27A and B. In a preferred embodiment, it will be understood that the humerus so shaped provides a structure that will assist in the formation of an airfoil shape along the inner wing. It will also be understood that S2 cam technology can be used to gain additional wing section swing modalities beyond the swing leverage provided by the reciprocator alone or reciprocator and spar rotational drive together.

The humerus 88 comprises the most complex portion of the wing structure in that aspects thereof comprise either exterior to, or alternatively within, the spar structure, gearing, (and in further and/or alternate embodiments comprises S2 cam pairs) to provide in the first instance the ability to rotate the spar clockwise and counterclockwise during both the articulation of the wing down and up as well as while the wing is in the soaring position, and secondly to provide a novel combination of the above stated wing articulation modalities and a novel method of applying cam-driven mechanical force, in addition to the reciprocator, to bring about wing articulation through the use of S2 cam pairs that in chain reaction-like movement can relay force from one cam set to the next directionally on the spar section to cause sequential sections of the wing spar to articulate. Further, the humerus 88 section comprises the hand gimbals as well as the main locking triggers for wing collapse. In a preferred embodiment, the location of these dynamic mechanisms on the inner most portion of the wing provides not only for the pilot to access the wing control modalities, the inner positioning also provides for sound structural configuration for the handling of the dynamic movements of the wing structure.

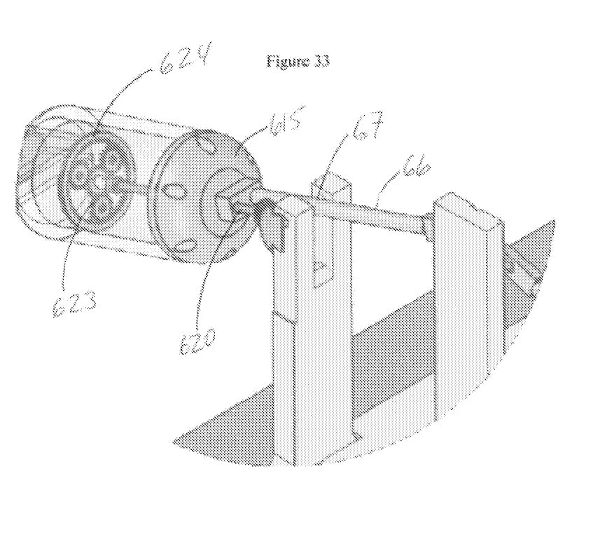

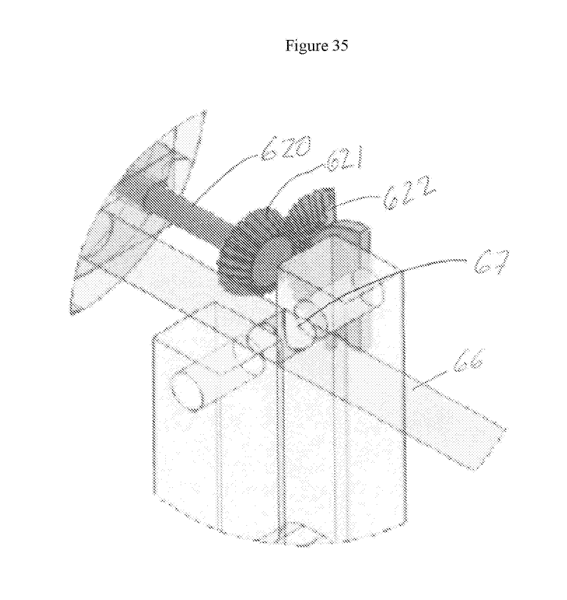

At the humerus' 88 proximal end 94, in one embodiment the humerus can have gear teeth 96 within the spar which mate with main wing rotation gear 97 that is part of a gearing mechanism associated with the lever arms 66L and 66R and their respective fulcrums 67L and 67R. As disclosed in greater detail below and modeled in FIG. 25, it will be understood that as the wing articulates down or up, the movement of the lever arm, as it moves through the arc of its swing, also rotates about the fulcrum axel which can possess gearing teeth that engage gears of a drive rod to which is attached the main wing rotation gear 97. As the main wing rotation gear 97 rotates about an arc of a range of degrees movement engaging gear teeth 96, the humerus is forced to rotate. Thus, the rotational energies, or otherwise torque forces applied to the humerus to cause wing spar rotation, occurs just outside the reciprocator lever arm fulcrums 67. It will be understood by one skilled in the structural arts that positioning of torque leverage at such position will provide for robust structural integrity of the wing as it experiences air flow pressures during flight. In an alternate embodiment, as disclosed in FIGS. 33 and 35, wing spar rotation upon wing articulation can be brought about using a gearing mechanism external to the humerus tubing. For example, the lever arm 66 can terminate external to the fulcrum 67 in manifold 615 which supports wing rotation drive rod 620. Wing rotation drive rod 620 can possess inner gear 621 which engages ratchet gear 622 which when the lever arm swings downward in a wing flap, the inner gear 621 being so engaged with the ratchet gear 622 forces rotation drive rod 620 to rotate. At the outer terminal of the rotation drive rod 620 is a planetary gear set 623 that acts similarly to the gearing depicted in FIG. 25, namely, the planetary gearing engages outer gear race 624 which is the equivalent, generally, of gear race 96 in that said race rotation results in humerus rotation.

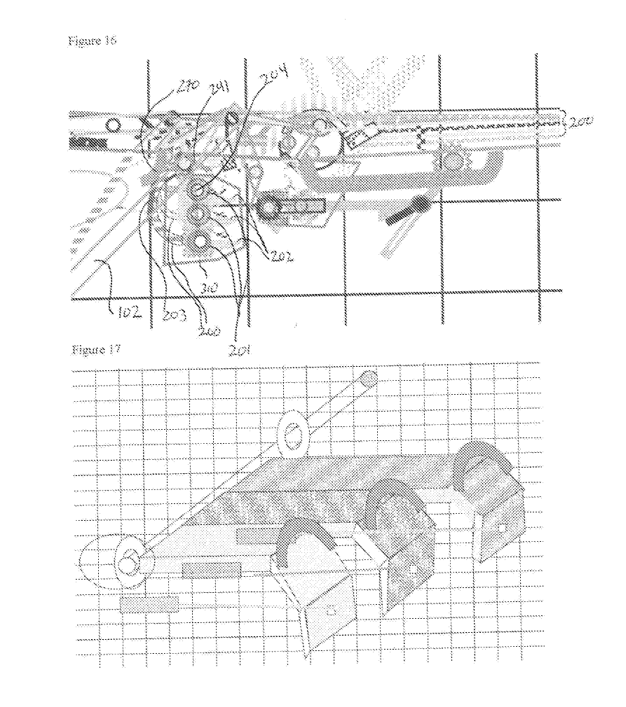

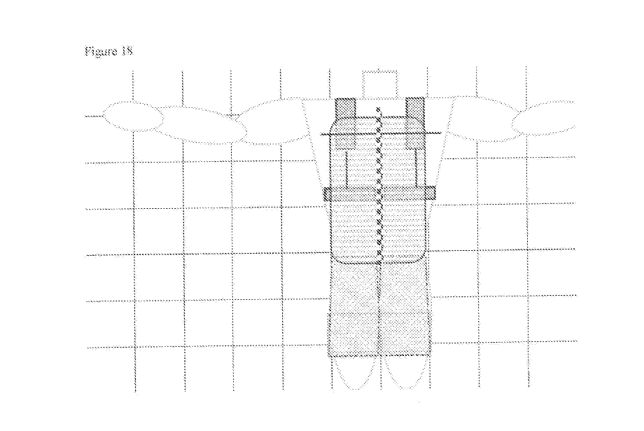

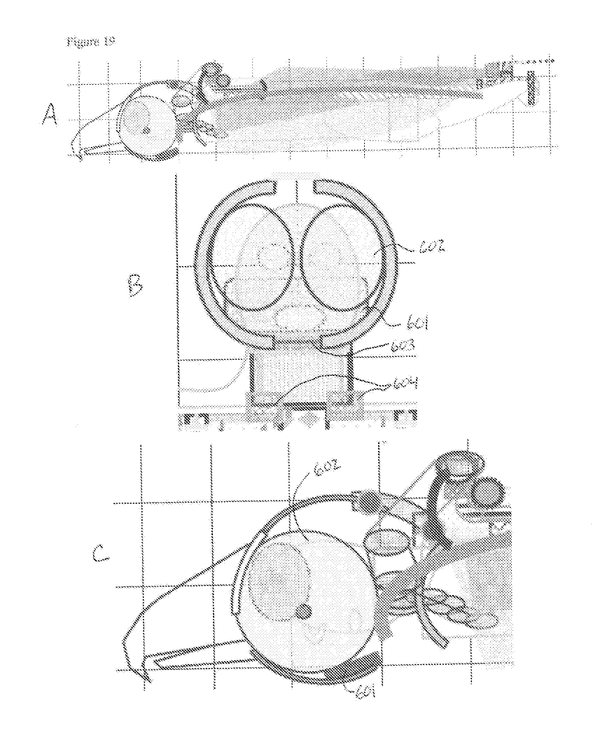

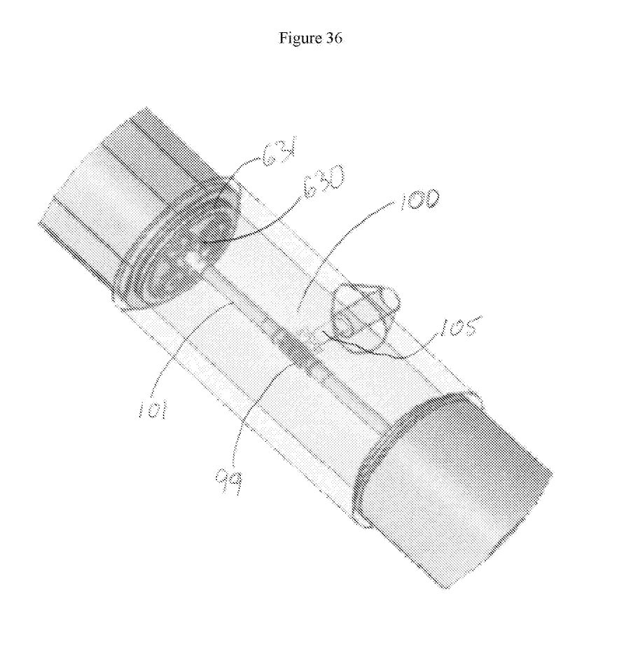

Exterior to the gear teeth 96 and humerus' proximal end 94 is the shoulder hinge 91, the configuration of which is disclosed in further detail below. From the shoulder hinge 91 the humerus structure leads head ward then angles frontward over the shoulders of the pilot and then laterally outward. As disclosed in FIG. 12D, at a distance D outward along the humerus 88 near where the humerus spar 88 begins its lateral direction outward, in a preferred embodiment, the lateral section of the humerus 88 leading out to its distal end 95 comprises three sections, x, y, and z, each of which have a proximal and a distal end. Section x is telescoped onto the inner portion of the humerus that comprises the inner curved/shoulder section. Section y is likewise telescoped onto sections x and z. By telescoped is meant that one section surrounds or covers a portion of the other. None of the sections x, y or z can slide telescopically on each other but can freely rotate with respect to their respectively adjacent sections. Section y possesses the hand gimbal and secondary wing rotation gearing mechanism 100 as disclosed further below (See FIG. 36). In one embodiment as set forth in FIG. 12D, within the distal end of section x is configured secondary wing rotation gear teeth 98 along the forward inner arc of the distal end of section x. The secondary gear race teeth 98 mate with a secondary wing rotation gear 99 and gearing mechanism 100 that operates similarly to that of the lever arm/fulcrum gearing mechanism. Specifically, secondary wing rotation gear 99 is connected to gear rod 101 which can be made to rotate from a torque source applied at the hand gimbal through hand gimbal gear rod 105 onto gear 99. Rotation of the gear 99 causes rotation of section x via gear teeth 98 while section y does not rotate. In the alternative, gear teeth race 98 can be replaced by a circular race that can engage planetary gearing associated with gear rod 101. The section y is kept from rotating in-part due to the attachment of section y to the body harness back plate via wing spar support strap 102 as depicted in FIGS. 12A, 12D and 16. In one embodiment as depicted in FIG. 12D, the configuration of section y with respect to section z is the inverse of how section y is configured in relation to section x. Specifically, gearing mechanism 100 wing rotation gear 99 leading external in section y terminates in wing rotation gear 103 that mates with rotation gear teeth 104 configured within the rearward inner arc of the proximal end of section z. Thus, the secondary wing rotation gearing mechanism 100 comprises one wing rotation gear rod 101 extending in opposite directions from the hand gimbal gear rod 105 that when rotated from the hand gimbal causes the rotation of sections x and z clockwise and counterclockwise in sync with one another. In the alternate, gears and race 103 and 104 can be replaced with planetary gearing and race, 630 and 631, respectively, as depicted in FIG. 36. This secondary gearing is used to articulate the leading edge of the lateral portion of the humerus wing spar primarily while the wing is in the soaring position. However, this secondary gearing can be used in conjunction with the primary wing rotation gearing at the shoulder to obtain maximum leading edge articulation up or down angles with respect to oncoming air stream. Further, the articulation of the humerus through the secondary gearing at the hand gimbals provides for the like articulation of the outer spar sections, i.e., the radius and carpal, of the wing due to their in-line connection to humerus section z.

In further embodiments, the humerus comprises between 1 and 4 Tertiary batten quill fittings that can be dynamic or not. Although it is not necessary for the Tertiary battens to rotate, the ability to so possess a degree of motion from dynamic quill fittings 41 (FIG. 9 shows typical spacing for fittings in the carpal section, FIG. 21 shows nature of dynamic quill fittings) will allow for minor adjustments in flapping motions as they are acted upon by a layer of fabric underlying the battens and through which the batten quills cross through to become inserted into their respective fittings. The shape of the Tertiary battens will depend upon the avian anatomy mimicked or otherwise chosen for aeronautic integrity.

Forearm. The forearm or radius spar 89 (FIG. 12B) is generally the longest section of the wing spar possessing a length of about between 5.5 to 6.5 feet. This section comprises the main airfoil that supports between 4 and 10 Secondary flight battens. Like the battens of the humerus section, the battens of the forearm can be fixed in position so that they cannot rotate or swing in angle with respect to the forearm spar length. However, in some alternate embodiments, it is contemplated that the battens of the forearm have the ability to slightly spread or be urged to adjust their respective angles in relation to the spar and therefore the batten quill fittings can comprise static or alternatively, dynamic quill fittings 41.

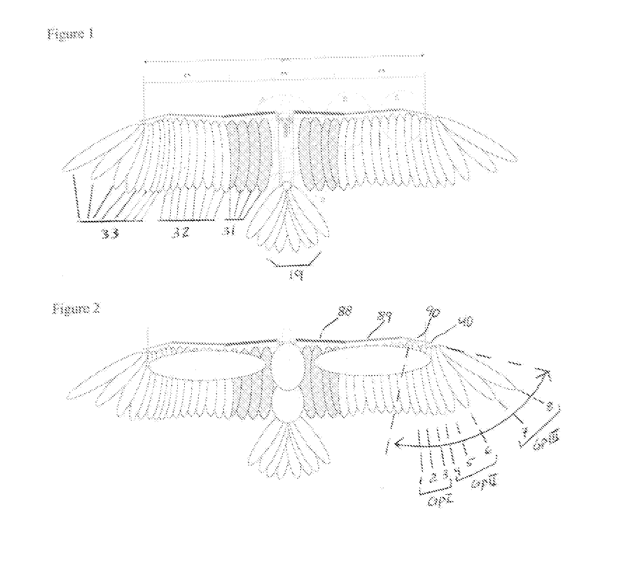

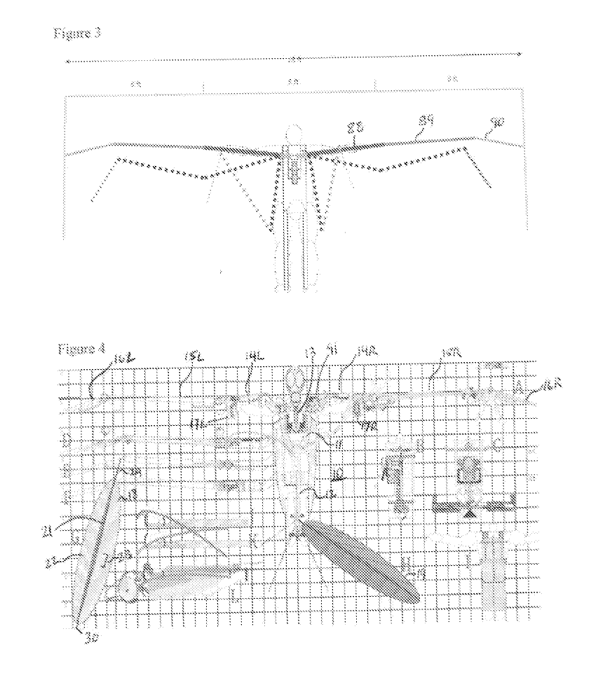

Further, as with the humerus, the forearm spar 89 (FIG. 2) is either shaped or comprises shaping that forms a curvature for creating lift along its leading edge. Although the forearm spar itself does not have in this embodiment dynamic attributes, it does possess elements that support carpal and Primary batten articulation wires and guide wheels and associated architecture as disclosed herein. Further, considering in the alternate the possible uses of S2 cams for achieving wing articulation, it is contemplated that the forearm section can have alternatively some dynamic capabilities. In preferred embodiments, avian-like flapping can be assisted by S2 cams.

Carpal. Generally, the carpal spar 90 is the shortest section of the wing spar possessing a length of about between 1.5 to 3.0 feet (FIG. 9). Similar to the humerus and forearm spars, the carpal spar is shaped to form the leading edge of an airfoil commensurate with the avian species around which the craft is designed. In preferred embodiments, the spar can be tubular and as stated earlier possesses along its rearward length dynamic quill fittings 41 that possess two directions of vector movement, namely a rotational vector and an angular vector. Generally, there are between 4 and 10 Primary battens per carpal spar which translates that there are between 4 and 10 dynamic quill fittings. With respect to the rotational vector movement, as shown in FIG. 21A, the center portion of the dynamic quill fitting 41 comprising the female quill fitting 34 is capable of rotating. The inner facing side of the dynamic quill fitting 41 further comprises a tab 42 that is connected to the center rotatable portion of the quill fitting and is used to leverage rotation of the batten. In preferred embodiments, the plane of the Primary batten panels are defaulted to lie on a parallel positioning with respect to the plane formed by the length of the wing spar 40. The batten dynamic quill fitting 41 will allow the batten to rotate in both a clockwise and counterclockwise motion allowing the leading edge of the batten to be adjusted with respect to the angle of attack of oncoming airflow. In other words, when the batten spar quill-like proximal end 29 is inserted into the rotational vector component of the dynamic quill fitting 41, the end cap 37 fixes the batten securely to the fitting 41and will be able to be made to rotate by manipulating the rotation tab 42. The rotation tabs 42 are manipulated by cables leading to the hand gimbals and springs which keep the batten orientation in default positions. In further embodiments, depending upon the number of battens placed on the carpal spar, the battens can be rotated individually or in groups or even all at the same time. For example, in one embodiment comprising 4 battens, each batten can move independently of the other 3 by an individually manipulable finger control at the hand gimbal (FIGS. 16 and 17). Alternatively, all 4 battens can be manipulated together from one control mechanism. In alternate embodiments, such as where there are 8 Primary battens, the battens can be rotatable in groups such as, for example, (FIG. 1) describing here from inside to outside, Primary battens 1, 2, and 3 configured to move together, while Primary battens 4, 5 and 6 are configured to move together, and outside Primaries 7 and 8 configured to move together, thereby making three levels or degrees of angular attack to oncoming air stream. In each case, the number of sets, whether a singular movement of all Primaries together or grouped, such as in three groups as stated above, will dictate the complexity of the control assembly for manipulating the battens at the hand gimbal. For example, in one embodiment, Primary batten control comprises cable lines 200 similar to that of a bicycle gear change cable leading from the rotation tabs 42 to the hand gimbal where they terminate at finger ring trigger/slides 201 that are capable of being pushed or pulled by light pressure using human hand finger digits such as the middle or bird' finger (no pun intended) where the Primary battens are manipulated in unison or by the middle, ring and little finger where the battens are configured to be manipulated in three groups. Alternatively, Primary batten control configuration can provide for the gimbal to employ the first or pointer finger, the middle finger and the ring finger. Additionally, the finger trigger slides as shown in FIG. 16 can incorporate slide ratchets 202 to temporarily hold the trigger at any range of positions so that the pilot will not have to keep finger tension constantly on the triggers. In alternate embodiments, the finger trigger arrangement can be configured as depicted in-part in FIG. 17. In this example, the fingers are kept in place with respect to the trigger which can be ratcheted back and forth. In further attributes, the hand gimbal can be configured to provide for automatic clamping of the finger slides any time the gimbal is manipulated so as for the pilot to activate other levers. It may seem complex but the relative arrangement of the piloting elements is designed to allow the ability to rotate the hand at the wrist, toggle the fingers and squeeze levers associated with the hand grip.

With respect to the angular vector, the battens, which can be between 4 and 10 battens, are angled at varying degrees with respect to the carpal spar. The specific angular positioning of the battens is contemplated to mimic the angular positioning of the avian species on which the wing structure is based. Generally, the range of angle can be at any position between zero degrees with respect to the length of the carpal spar and ninety degrees with respect thereto. As shown in FIG. 1, the Primary flight battens are angled closer to parallel with the carpal spar the farther out the Primary batten is placed on the carpal.

Wing Spar Dousing. It will be appreciated by one of knowledge in avian flight behaviors that birds commonly adjust the amount of surface area of the wing during flight for a multiplicity of aerodynamic reasons. For example, in sharp dives, such as with falcons hunting prey, the avian will completely collapse the wing so as to drop like a stone. Lesser degrees of wing collapse are also performed such as bending the shoulder to bring in the humerus, and/or bending the elbow and shoulder to increase shortening of the wing, or further still, bending additionally the wrist to bring in the carpal. Any one of these respective movements can be made independently of one another but commonly avian species are observed to douse primarily the carpal while the humerus and forearm remain in soaring position. Such behavior is witnessed often when the bird is traveling along a cliff. In such setting, wind directed towards the cliff face, such as conditions often occurring at a sea shore where the wind is traveling from the ocean towards the shore, will be forced to rise up as it hits the cliff face providing an up draft. Typically, under such wind conditions, the air traveling closest the cliff face has a stronger upward vector force than lateral or shoreward movement. Depending upon the speed of the wind stream, the upward force can be substantial. With respect to a bird traveling along such a cliff face with strong upward drafting, a bird soaring along said cliff face will douse the cliff ward wing so as to maintain a level flight orientation. Specifically, by dousing the cliff facing wing, the bird essentially lowers the amount of lift provided by the stronger upward air stream while allowing the outward wing to remain performing its lift function in normal or near normal soaring position, thereby taking advantage of the ever so slightly less amount of upward air stream forces acting at opposite ends of its furcrum-like body. In preferred embodiments, the current avian soaring platform also provides for variable degrees of wing ‘dousing’ for each of the humerus, forearm and carpal spar sections.

Carpal Spar Dousing. With respect to the carpal section, it will be appreciate by one of skill in the flying arts that the current invention provides an on-demand temporary partial collapsing of the carpal spar by bending the wing at the wrist hinge. As shown in FIG. 9, carpal dousing cable 206 leads from the hand gimbal lever 204 (FIG. 16, blue bar depicted under hand gimbal finger holes) when pulled acts upon the wrist hinge locking key 207 (FIG. 9) followed immediately by action upon lever arm of S2v cam 208 which action in turn causes S2t cam 209 to rotate causing its opposite extension, leverage arm 210, to arc rearward and in doing so pulls the carpal rearward via gearing wheel 211 rolling in leverage arm power slide track 212. The S2 cam system allows the degree of rotation to be set to a limit of arc. Although FIG. 9 depicts this aspect of the invention in two dimension, it will be readily understood by one of skill in the mechanical arts that the movement of the above stated dynamic elements relative to one another is possible from the spatial arrangements of the individual elements. Specifically, the S2 cam set is anchored to a planar aft extension plate attached to the outer portion of the radius spar. That outer portion of the radius spar is angled dorsally or downward slightly from the position where the S2 anchor plate begins on the inner side thereof. This aspect provides for the S2 cams and related leverage arms to be in-line with the plane of the carpal spar and wrist hinge. As depicted in FIG. 9, the lever arm 210 and cam set lie spatially above the power slide track 212 such that the gearing wheel 211 on its axel lies lower than the lever arm 210 and rides in the power slide track 212. Upon activation of the S2 cam set, the lever arm 210 via the gearing wheel 211 and slide track 212 forces the carpal section rear wards, dousing the lift capability of the carpal wing section. Because the cabling is set to a maximum travel, the carpal will only swing a set degree of movement. However, if the main locking mechanism of the wrist hinge is disengaged, the gearing wheel 211 will ride towards and contact a trip ratchet 213 allowing for the gearing wheel 211 to enter slot 215 in the lever arm 210 upon the trip ratchet causing rotation of a U-shaped element associated with the axel of the gearing wheel, and wherein the 90 degree rotation of said U-shaped element allows the gearing wheel axel to enter the slot 215 and thereby allowing the carpal to further swing for collapsing that wing portion without the lever arm and S2 cams needing to rotate further themselves. This means that in a fully collapsed carpal section position, the lever arm will protrude forward of the carpal spar. This is allowable as the battens and spar will be positioned slightly above the slide track. In a further aspect, the activation of the lever 204 at the hand gimbal, in pulling on the same cable as the S2 cam activation cable, also pulls on a secondary cable connected to the S2 cam activation cable that is itself leading to a disengagement key that will disengage, temporarily unlocking the wrist hinge allowing the action of the S2 cam set to swing the carpal spar. This temporary disengagement is brought about by a slide mechanism shown in FIG. 9B that allows the main locking key for locking the hinge in flight to be moved in isolation to locking keys for the shoulder and elbow hinges. In other words, when the gimbal lever(s) is/are squeezed, whether that being the levers controlling dousing of the carpal, radius or humerus spar sections, the slide mechanism of FIG. 9B (of which there is one for each S2 cam set of the wing sections), will cause disengagement of the main locking keys of the hinges to allow their respective S2 cams to operate. The degree of dousing swing collapse is not as complete as when the wing is completely collapsed because the dousing cam travel is limited. Thus, by such limit, it acts structurally to support wing orientation whether fully opened or fully doused. Beyond fully doused for the wing section is full collapse which mechanism and processes are disclosed below. The sliding key unlocking mechanism comprises a ratchet that is anchored on a guide wire running to the hand gimbal dousing lever. The guide wire is itself anchored at its distal end with a tension spring. The ratchet is positioned so as to be able to slide on the main locking cable just distal to the respective hinge lock. When the dousing lever is squeezed, the guide wire is pulled, stretching the tension spring and the ratchet can move towards the hinge lock. When the ratchet engages the hinge lock it trips the lock to open position. If only the main locking cable is activated, it will immediately disengage the hinge lock.

Forearm Spar Dousing. As depicted in FIG. 10 the forearm spar can be doused using the same means as for the carpal dousing but here the nature of the leverage arms and its mounting relation on the humerus in relation to the direction of swing of the forearm are different and require a modified leverage arm. Specifically, activation of lever 203 (FIG. 16, (blue bar under wing brace 102 and above cables 200) at the hand gimbal causes cable 219 (FIG. 10) to pull on S2u cam 220 which rotates S2t cam 221 and leverage arm 218. The S2 cam set is positioned on anchor plate 228 that is connected to the rearward terminal area of the humerus spar. Although depicted in two dimension in FIG. 10, it will readily be understood by one of skill in the mechanical arts that cam anchor plate 228 lies lower in spatal positioning relative to slide track 222 slightly allowing for roll gearing 223 to travel in the track as said gearing is attached to the lever arm extension 226 by an axel protruding upward towards the slide track 222. Leverage arm 218 forces its extension arm 226 to roll gearing 223 in power slide track 222. When the leverage arm reaches the limit of the S2 cam swing, the wing cannot collapse further due to the slide lock lever 224 which is not tripped until the S2 cam stop is deactivated by pulling main wing folding lever 217 (FIG. 11) further which allows the cams to rotate a small degree further allowing a tang 227 to urge slide lock lever 224 open and the gearing wheel 223 to slide into slot of leverage extension arm 226. Tang 227 is positioned on cam anchor plate 228 as shown on FIG. 10. As with the wrist main locking key, the elbow hinge locking key 257 is activated on squeezing the lever 203 via the key slide mechanism of FIG. 9B.

Humerus Spar Dousing. FIG. 11 depicts the dousing mechanism of the humerus wherein pulling cable 229 disengages shoulder hinge lock 91 and S2u cam 230 lever which in turn forces S2t cam 231 and its leverage arm 232 to rotate and gearing wheel 234 to roll in power slide track 233. As depicted, the S2 cam set is anchored on a planar extension on the portion of the humerus just outside the fulcrum, essentially the same portion comprising the spar/wing rotational gear race for rotating the wing during wing articulation. The S2 anchor plate is in-line with the plane of the slide track 233. The shoulder hinge is equipped with a safety hinge 236 that does not get dislodged unless main wing fold lever 216 is pulled to completely fold the wing at the shoulder hinge. The safety hinge 236 allows the humerus to maintain a stable orientation with respect to the reciprocator side of the hinge and allows the humerus to swing to the limits of its S2 cam-based dousing mechanism but stops further unfolding unless the main fold lever 216 is pulled to release the safety hinge, and from that position the gearing wheel 234 will trip the same U-shaped switch mechanism as disclosed above and allow the gearing wheel 234 to slide in the lever arm 235 slide track 236. The primary purpose of the safety hinge 236 is to help ensure resistance to rotational torque on the wing structure relative to the body harness and reciprocator mechanism as it is the shoulder region of the craft that experiences the greatest aerodynamic forces in flight.

Additional Dousing and Other Embodiments. It is to be understood that S2 cam system modality primary arises due to the ability to leverage linear movement of lesser arc to one of greater swing which here aids in lessening the grip force necessary to activate dousing. Additionally, the degree to which an S2 cam can rotate relative to one another can be limited as well as set within parameters of swing and as well as defaulted to any of at least one of a type of default setting such as half way between fully resting or fully opened, or defaulted to fully open. Further still, whether employing S2 cam systems or any other cam system, default settings can be accomplished using spring adjusted systems meaning that a spring system, whether single stretch or compression or twist spring or a dual spring compression, or dual stretch and compression, or dual opposing twist springs can be used to urge the cam in a resting position. If the cam is moved to stretch or compress or twist the spring, the cam will be urged by the energy held in the activated spring to return to the resting position. Such positions can also be managed by electronic devices such as servos, and the like, alone or in addition to springs, as one of skill in the electrical arts would readily comprehend.

With respect to more dousing capability, the wing can further comprise the ability to partially collapse by bending at the wrist alone or at the wrist, elbow and shoulder in varying degrees of relative swing or collapse. It will be understood by one of skill in the art that any range of degree arc can be contemplated between zero and ninety degrees swing but for practical reasons is limited to a smaller range of arc such as for example, between five and 50 degrees. In preferred embodiments, the ratio is adjusted to provide for lesser degrees of swing for the inner wing spars as compared to the carpal such that the humerus experiences the least degree of swing while the forearm experiences a larger degree of swing than the humerus and the carpal experiences an arc swing greater than the forearm while performing dousing maneuvers. In still further preferred embodiments, not only is the degrees of swing different for each spar section, the rate at which the swing is allowed to become manifest relative to other spar sections is variable over the degree of pull swing which in turn is determined by the pilot's grip squeeze on the dousing activation levers (FIGS. 16 and 12B), and the cam-driven degree of movement in the slide key unlocking system (FIG. 9B). Specifically, if for example, the pilot squeezes the carpal dousing lever 204, the rate at which the carpal will swing through its arc movement will be greater per amount of lever pull than when the humerus/forearm lever 203 is squeezed to cause their travel. As noted above for each spar length dousing, using the carpal dousing elements as an example, the rate of swing is controlled, in-part, by the power slide track 212 and gearing wheel 211 at the end of the leverage arm 210. The same is true for when the shoulder and elbow hinges are articulated to douse the humerus and forearm. When the pilot squeezes lever 203 the humerus and forearm will arc through their degrees of travel due to their respective S2 cam systems and leverage arms 232 and 218, respectively, yet the rate of arc travel along their respective tracks will be limited by the gearing of the gearing wheels. It will be appreciated that the forearm will douse at a higher rate than the humerus while the carpal will douse at a higher rate than the forearm.

To accomplish such in-flight manipulation of the wrist and elbow joints, it is contemplated that in one alternate embodiment the hand gimbal can comprise finger levers that are oriented with respect to one another similarly to a double trigger of a double barrel shotgun. Specifically, the levers function by applying pressure thereto using, for example, the index finger which can modulate the pressure to be applied to each of the trigger levers. In this instance, the upper trigger douses the carpal spar while the lower trigger douses the forearm spar. The lower trigger can be set to rest at a position where the trigger cannot be activated until the upper trigger has been squeezed a set degree, for example. This provides for varying the relative bending of the wrist and then elbow hinges, respectively. In an alternate particularly preferred embodiment, the dousing of both wrist and elbow is accomplished using a single trigger wherein the degree of bending the wrist and elbow and therefore the degree of dousing is determined by the degree of pressure applied to the lever. The greater the pressure or squeeze of the lever, the greater the bending of the wrist followed by bending of the elbow. In such single lever mechanism, the degree of bending at the wrist and elbow relative to one another is set so as to in one aspect, not allow the unlocking of a shoulder, elbow, or wrist hinge until the requisite linear degree of pull, and consequent stretch on the retention spring of the sliding unlocking key mechanism as it is pulled into place, will the dousing begin such that dousing will not begin at the elbow until after the wrist has begun to douse the carpal, there being a set ratio of increasing elbow bending as the carpal is doused to a greater and greater degree. It is contemplated that any number of ratios of increase can be applied.

With respect to the actual mechanism, whether a double or a single trigger modality is chosen, the dousing actions by bending of the wrist and elbow hinges is the same. Specifically, as contemplated for the configuration of the hand gimbal, for an example, lever placement, such as in FIG. 16, discloses a lever 203 to be activated by squeezing the palm area of the hand against a central handle grip while a second lever 204 is to be activated by squeezing the lever against the central handle grip using one or more fingers. This configuration is different from those disclosed above and is a dual lever action with the levers acting in opposite directions of one another. The direct analogy is squeezing a pair of pliers that is kept open with a spring that compresses when the handle grips are squeezed. This same action is the look and feel of the dousing levers depicted in the present figures. Each lever can be operated separately or together providing for versatility in dousing wing surface area. Alternative configurations as stated above can comprise dual levers to be squeezed by the fingers and that compress at different rates so as to not activate inside wing (humerus and/or forearm) spars until the carpal spar has begun dousing. Ultimately, a means is contemplated to allow the dousing of the three spar sections by toggling a lever means to activate mechanical or electronic drivers and adjust the wing spar relative orientation at will.

Carpal Spar Rotation. As disclosed in FIGS. 12C and 12B, the platform comprises a cable 240 from the hand gimbal where there is located a finger trigger 241 which when pulled, typically when the wing is about to be articulated, causes the carpal and outer end of the forearm to rotate forward. With respect to the right wing forearm spar rotation, the rotation would be clockwise observing the platform from the right side. For the left wing, the rotation would be counterclockwise viewed from the left side of the platform. The rotatable section ca begin in one embodiment at the latter section of the radius wing spar. In preferred embodiments, the wing spar will deviate at an angle dorsally and aft of the linear path projected by the radius spar. This will allow for the wrist hinge to lie between the radius and carpal after such directional deviation of the wing spars.

When the wing articulation trigger 241 is pushed, the wing will swing down while the spar itself is rotating from the shoulder through an arc. The wing spar sections themselves can be rotated simultaneously via rotation of the hand gimbal (clockwise for right hand, counterclockwise for left hand) to set the leading edge of the spar at the extreme down (or up), angle, and a further squeeze of the finger trigger will cause the carpal to rotate downward (i.e., clockwise/counterclockwise). All this action will force thrust down and back as does the action of a bird's beating wing.

Carpal spar partial downward flexing during up swing. In additional modalities of the articulating wing capability, the wing spar at the forearm/carpal intersection is contemplated to have the ability to slightly bend on the up swing during wing articulation. As will be understood by one of skill in the art, the carpal wing section can be operated to automatically bend down whenever the forearm spar is rotating up or (for the right wing rotated counterclockwise when viewing from the right side and for the left wing rotated clockwise when viewed from the left side of the platform). In this embodiment, a special S2 cam set can be incorporate into the wing spar near where the swivel is located on the radius. The cams can also be activated at will by cable such as whenever the hand gimbal is rotated (counter clockwise for the right hand and clockwise for the left hand), the S2 cam system will pull on the cable line and leverage the cams thereby making the carpal section articulate.

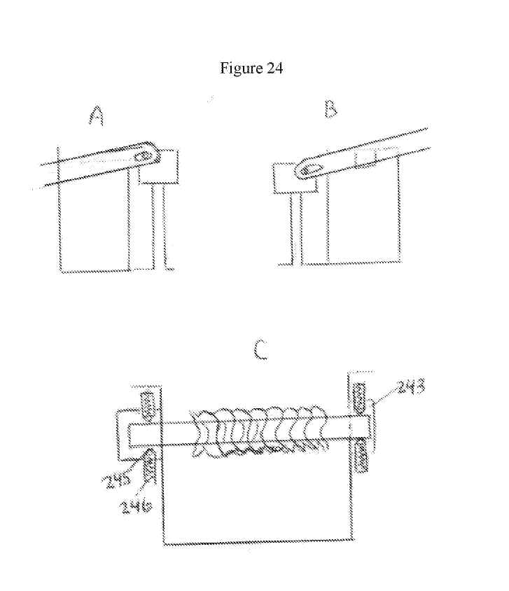

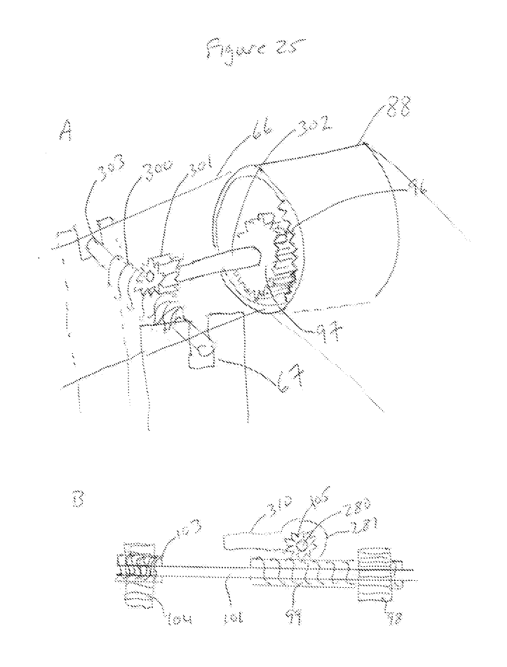

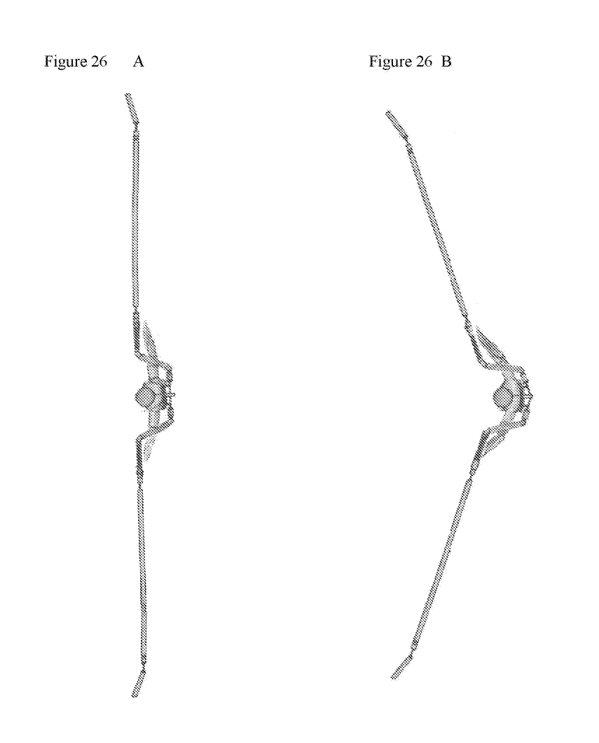

Wing Articulation. As noted elsewhere the wing articulation is brought about by a reciprocating mechanism. The mechanism essentially drives a piston that in the instant case comprises a segmented shuttle and terminal block. As Shown in FIGS. 24A, B, and C the reciprocator leverage arms are pushed and pulled to arc about a fulcrum 67. The fulcrums 67 are fixed and comprise a fulcrum axel 242 that is itself fixed into position in the lever arm 66 so that it cannot rotate with respect to the lever arm 66, i.e., it rotates with the rotation of the lever arm. Thus, rotation of the lever arm in the fulcrum comes about by the outer lengths of the fulcrum axel being allowed to rotate in their respective mounts. In one embodiment, the fulcrum axel mounts are designed to possess a floating quality in that the axel can rock back and forth or up and down in its cradle 244. The floating means can comprise a spring 246 based bearing 245 on the top and bottom of the axel cradle 244 wherein the bearings can rise and fall within a range typically of between 0.1 inches and 1 inch depending upon relative pressures applied to the lever arms 66. In one example, a downward beat of the wing will urge the axel downward but wind action will tend to urge the axel upward. These competing forces will act on the fulcrum axel to the effect of reducing stress on the reciprocator and fulcrum action. The action to bring about rotation of the wing spar is depicted in FIG. 25 wherein it is disclosed that rotation of the wing spar arises from the action of the down swing of the lever arm 66. By swinging down, the lever arm rotates about stationary fulcrum axel 303 causing gear 300 attached thereto to cause rotation in Gear 300 which acts on gear 301 which rotates spar rotation main axel 302 and wing spar main rotation gear 97 which engages gear race 96 attached to the leading edge of the humerus spar end. Gearing is configured so that a downward swing of the lever arm results in a clockwise rotation of the right wing as observed from the right side and counterclockwise for the left wing as viewed from the left side. It will be understood that the opposite movement of the lever arms, i.e., moving up will cause the wing spar to rotate opposite to the rotation while swinging down.

Wing Hinge Construction. The shoulder, elbow and wrist hinges are designed to provide extreme robustness to resist twisting and breaking. Each of the shoulder, elbow and wrist hinges comprise disc/plate construction wherein there are intersliding plates that maintain the relative orientations of the respective adjacent spar sections. The shoulder hinge is configured to open so that the humerus swings laterally aftward, the elbow hinge is configured to open so that the forearm swings forward, and the wrist hinge is configured so as to cause the carpal to swing aftward.

Shoulder hinge. The shoulder hinge, as shown in FIG. 11, is centered on the trailing side of the humerus section at the connection between the lever arm 66 and humerus. The hinge is kept closed by hinge lock 91 and safety lock 236. The hinge lock 91 is the primary lock that must be opened to fold the wing. The hinge lock 91 must also be opened for dousing maneuvers. Because the shoulder hinge carries all of the weight of the wing it is under the highest relative stress. Therefore, to help lessen stress the hinge comprises a safety hinge lock 236 that guides the opening of the hinge and keeps the outer section thereof from twisting as the safety hinge is hard mounted to the inside portion of the humerus while the outside portion of the safety hinge slips through the humerus body. The safety hinge will allow the shoulder hinge to open up to a degree of arc movement that is controlled by the limit of the S2 cams 230 and 231 swing and the safety hinge limit The hinge lock 91 locking key 250 is urged out of the way by sliding on a dual latch mechanism as depicted in FIG. 9B. Specifically, leveraging cable 229 will pull the locking key 250 out of the way allowing hinge lock 91 to open. Further tension on cable 229 will cause the shoulder hinge to articulate as the further pulling on the cable activates S2 cams 230 and 231 which results in rotation of leverage arm 232, rolling of gearing wheel 234 along power track 233 out to the limit of the S2 cam rotation which is the same point at which the safety hinge limits opening of the shoulder hinge. The safety hinge lock 236 is unlatched by pulling on the wing fold lever 216 which allows the hinge to swing a small degree further as allowed by the extreme limit of movement allowable by the S2 cams which further arc movement allows U-shaped slide lock 251 to rotate by the contact with ratchet 252 on the power track 233 further allowing the gearing wheel 234 to slide in the lever arm extension 235 slot 236 as the wing spar is pushed into fully folded position.

It is to be understood that positioning of cable races and pulley wheels managing the wire and cables in or along the wing spars is based on best leverage alignment and maintenance of thereof. Where cables must cross a hinge it is directed to the outer most side of the hinge swing center point. This positioning allows the spar sections to be folded without causing stretching of the cable. This positioning is brought about by placing races on the main hinge. These multiple raced hinges are easy to produce and can comprise stacked layers of races so that a multiplicity of cables and/or wires can transition about a single pivot point.

Elbow Hinge. As depicted in FIG. 10, the elbow hinge center of arc swing (pin) lies at the leading edge of the spar. This main hinge pin 255 is configured as a multirace pin servicing numerous control lines leading to the carpal spar. The elbow hinge is locked by a single hinge lock 256. The hinge lock can be opened via sliding locking key 257 out of the way. Locking key 257 can be moved using main wing folding lever 217 or activating humerus/forearm dousing lever 203. The hinge will swing according to the S2 cam 220 and 221 limits and the lever arm extension 226 will not trip slide lever 224 unless the main wing folding lever 217 is pulled which not only moves locking key 257 to unlock the elbow hinge, but also disengages the S2 cams 220 and 221 stop, allowing the cams to swing a small degree further which allows slide lever 224 to active which in turn allows gearing wheel to slide in leverage arm 235 slide slot 236 and subsequently complete collapse of the forearm spar. It is to be understood that activation of the humerus/forearm dousing lever 203 will first activate the locking key 257 in the elbow hinge and secondarily activate to unlock the locking key 250 in the shoulder. In this fashion dousing of the forearm can commence independently or totally without or alternatively with dousing of the humerus spar section.

Wrist Hinge. The wrist hinge can be situated as shown in FIG. 9A just outside the downward leading outer end of the forearm (such as depicted in FIG. 27C. This wrist hinge has its center of arc pin 258 lying at the rearward side of the wing spar. Locking key 207 locks the hinge lock 260 and can be urged to unlock by activating the main wing fold lever 217 or alternatively activating the carpal dousing cable 206 which is so activated by squeezing the lever 204. It will be appreciated that the S2 cams 208 and 209 will reach the limit of their swing stop and that the wing will not collapse any further unless the main wing fold lever 217 is fully extended so as to cause disengagement of the S2 cam stop enough to allow the cams to swing slightly further allowing the engagement of U-shaped switch 214 to engage ratchet 213 further resulting in the rotation of the U-shaped switch 214 ninety degrees so that the gearing wheel 211 cm slide in the leverage arm extension slot 215 and the carpal spar to collapse.

Collapsing of the Wings. Although the wing dousing mechanisms cause the complete disengagement of the locking keys that otherwise keep the wing spar hinges locked and wing spar sections rigidly in place, the action of the S2 cams and leverage arms maintains the wing in a set flyable orientation despite the potential for extreme loss of airfoil lifting surface area with all three levels of wing dousing fully activated and the respective wing spars fully doused. However, to bring about a complete collapse of the wing, the platform comprises wing locking system comprising locking levers for each hinge, namely the shoulder 91, elbow 92, and wrist 93 hinges. If complete collapse is desired in the wing, referring to collapse of the carpal as an example, the slide track 212 comprises a ratchet 213 that when the leverage arm 210 reaches a specific point in its travel within the track 212, the ratchet trips a U-shaped switch 214 in gearing wheel 211 forcing it to rotate 90 degrees which causes the gearing wheel to slide into the slot 215 in lever arm 210 thereby allowing the spar to follow. It will be appreciated that the S2 cam is allowed past its limit by the activation of cabling from main wing fold lever 217 wherein when lever 217 is activated to release the wing spar hinge locks, the locking keys of each of the elbow and wrist hinges are disengaged and the limit stops are urged out of the way in the S2 cam systems for the carpal and forearm dousing mechanisms Similarly, the shoulder hinge 91 dousing mechanism provides for its leverage arm to swing through an arc of travel but reaches a limit beyond which complete collapse cannot occur unless the main wing fold lever 216 is activated which also disengages the humerus S2 cam limit Like the carpal dousing lever arm and slide, the shoulder lever arm gearing has a U-shaped locking means that when tripped will allow the gearing mechanism and lever arm to travel so as to allow the wing sections to collapse. Once the cam limits are out of the way, each wing spar section can be completely collapsed. It is to be appreciated that only releasing the main wing fold levers will the S2 cam limits be moved out of the way. Where other cables are activated to release respective hinge locking keys, the wing nonetheless cannot completely collapse due to the dousing leverage arms and limits of wing spar swing set by the S2 cams.

Hand Gimbals. As disclosed in FIG. 16, the hand gimbals are multi-component systems comprising a hand grip 281 that is splined onto a gear axel 280 (FIGS. 12D and 25B) as a central element. The gear axel stands out from the wing spar by a race 282 that can freely rotate on the gear axel 280 between the wing spar and hand grip. On the inside of the wing spar section, the gear axel 280 is affixed to gear 105. Gear 105 engages gear 99 on cross axel 101. Cross axel 101 runs the length of the humerus spar sections x, y, and z, terminating at its inward facing end within the inner section of the humerus. Cross axel 101 has gears 99 and 103 configured so that gear 99 engages gear race 98 affixed to the inside leading side of the humerus section x while gear 103 extends into the end of the forearm spar and engages gear race 104 positioned on the inside rearward side of the forearm spar. The purpose of the hand powered rotation of the hand grip is to provide for modulating the rotation of the wing spar. It is contemplated that a clockwise rotation of the right hand will result in clockwise or downward rotation of the right wing spar humerus sections x and z as well as forearm and carpal spars. Additionally, the degree of arc rotation is contemplated to range between zero and ninety degrees of arc movement, but it is intended that arc movements will generally range between zero and forty five degrees. In further embodiments, the gearing at the ends of cross axel 101 can be planetary gears activating a circumferential gear race instead of a race placed forward or rearward within the spar sections as disclosed above. In any event, the base conception of the steering hand gimbal is for utilization of rotational energy to accomplish wing spar rotation in the soaring position. Leverage by applying rotational energy is a preferred methodology for steering as such allows for use of human muscle power in piloting the platform while expensing little energy.

Continuing with preferred embodiments, combined with the hand grip is palm section 310 which allows for further surface area for controlling with the hand and which provides a structure to incorporate finger slide trigger elements for articulating the Primary battens. In preferred embodiments, the platform is contemplated to comprise three finger slides 201 as depicted in FIG. 16 but alternatively can comprise two or even a single finger slide. The finger slides can be easily pushed and pulled by the fingers wherein the cables slide out to the Primary battens. The cabling is fed into the rear and downward side of and inside the hand grip. Since the hand grip can rotate, the cabling must accommodate the twist without the twisting causing the Primary batten cables to be affected. This is accomplished by placing the primary cable housing support bar directly on the race 282 that is centered on the hand gimbal axel 280. This allows the hand gimbal to rotate and the cable supports to allow freedom of cable and housing movement without imparting force onto the cables. In one embodiment, the finger slides can be temporarily set at given positions without the pilot having to maintain finger pressure on the slide. This is accomplished using for example a spring ratchets 202 that lightly grips the slide or cable.

The hand gimbal further comprises levers to bring about dousing of the humerus, forearm and carpal wing spar sections. Specifically, the carpal wing spar section can be doused by squeezing lever 204 which is easily gripped by the finger tips of the pointer, middle and ring fingers. The ability to grip and squeeze lever 204 may seem difficult to do while the fingers are transiting through the finger slides 201 but due to the slight movement necessary to change Primary batten angle, the lever 204 will be placed so as to ergonomically result in the fingers being able to squeeze lever 204 without appreciably impacting the finger slide positions. The hand gimbal further comprises lever 203 which activates dousing of the humerus and forearm wing spar sections. This lever is activated by squeezing the rear side of the hand grip. In an alternate embodiment, the lever 203 can be place on the forward side of the grip such that as lever 204 is squeezed, lever 203 is not engaged or activated until lever 204 is activated and the carpal spar is already in dousing mode. In still further embodiments, the hand gimbal comprises lever 241 which can be operated by the index finger. Lever 241 causes rotation of the carpal which is commonly performed when the wing is articulated. For example, the right hand gimbal is rotated clockwise and the lever 241 is squeezed followed by pushing the articulation button with the thumb. In still further embodiments, the hand gimbal comprises main wing articulation button 271 configured to be place so as to be activated by thumb pressure. Pushing the trigger button 271 releases the driving gear of the reciprocator allowing it to cycle. Continuous pressure on the button will result in continuous flapping of the wing. In one embodiment, the articulation button 271 cannot be activated unless the hand gimbal has been rotated so that the spar is preset in the down position. This feature provides for maximum and consistent power to the articulating wing.

In still further embodiments, the hand gimbal is associated with levers 400 and 401 which activate via cable the locking mechanisms that maintain the reciprocator box in its normal position but when released by pulling the levers, the front or alternatively the rear, or even both rear and front latches are released and the reciprocator box allowed to swing out and away from the back plate. Additionally, activation of the cabling causes the thigh seat belt-like support straps to release first, allowing the pilot to move his legs out from the pedal spar in anticipation of landing before the reciprocator forward and/or aft ward locking means are tripped.

Body Harness. The central structural component of the soaring platform comprises the body harness. In preferred embodiments, the harness is configured as a farmer john style thigh length sleeveless vest. The vest can be a step-in style in that the pilot would step into the thigh portion or it can be a wrap-in style wherein the pilot affixes the thigh portion by wrapping harness fabric about the thighs and crotch and securing it such as by hook and loop means such as Velcro™ and/or buckles of a wide variety as are well known to those in fastening arts. The portion covering the dorsal torso comprises a form fitting back plate that is comfortably padded with semi-resilient material. The areas matching with a pilot's shoulder blades are designed to be flexible by any of numerous means such as floating areas of back plate with a multiplicity of springs holding the movable portions in a default position. Alternatively, the areas around the shoulder blades can comprise openings in the back plate to allow free movement of the shoulder blades so that they will not rub or uncomfortably contact the body harness structure surface.

The back plate has attached to it the reciprocator which is itself connected to the back plate through a dual slide rail that allows the adjustment of the reciprocator on the back plate fore and aft (see FIGS. 39A and B). This aspect allows for adjustment of gravity center of the soaring platform with the airfoil. In another preferred embodiment, the body harness is configured to possess an inner layer and an outer layer such that the inner layer is adjacent to the body of the pilot and primarily comprises elements for attaching the platform to the body such as straps and buckles. The outer layer is itself multi-layered and comprises the outer shell of the platform body. This outer layer can comprise body protection material such as bullet proof composite, insulation, and exterior fabric which itself can comprise natural and synthetic plumage woven therein.

Once ‘dressed’ in the body harness, the pilot standing in the vest with arms through the arm openings and legs through or wrapped into the thigh section, can “zip” up the front of the harness or otherwise affix the left and right front vest portions together by a multiplicity of means including zippers, buckles, claps, snaps, buttons, and hook and loop fasteners. In a preferred embodiment, the fasteners individually and collectively provide for failsafe closure of the first or inner layer of the body harness vest's front or ventral side. The inner layer is configured to be relatively stiff but resilient to body form. Having such quality allows for the harness to remain firmly against the body in a comfortably manner Further, comfort is created by novel design placement of inner vest fabric/material that allows the body to feel comfortable lying in a prone position while being strapped essentially onto and within a rigid platform. In particularly preferred embodiments, the body harness is rigid on the dorsal side from the shoulders to below the buttocks of the pilot while the thigh portion is also rigid along the front hemisphere of the thigh to above the knee and semi resilient from the lower abdomen to above the waist while the portion covering the mid abdomen and lower chest are more resilient than the immediately preceding material to allow for breathing and chest expansion, and the upper chest and shoulders portion being more rigid to help maintain consistent positioning of the pilot's shoulders against the back plate. Further, the materials used on the inner vest layer provide for keeping the pilot snuggly and securely fitted to the soaring platform. In this inner layer fabric and closure system are shoulder, abdomen and hip adjustment/tensioning cross straps that are used to snug the pilot to the harness.

As depicted in FIG. 19A, the outer layer comprises three layers, namely an inner layer comprising shaped buoyancy pockets configured about the body harness so that at least one separate pocket is positioned dorsal to the foot pedal spar and lower dorsal torso, at least one separate pocket is positioned ventral to each wing in symmetric fashion with respect to left and right, and at least one separate pocket is positioned on each left and right half of the ventral abdomen and chest portions of the vest. Connected exterior to this inner pocket layer is an middle layer comprising strike resistant material. By strike resistant material is meant resistant to piercing by a high velocity projectile, for example a bullet proof material of which many useful and light weight materials are well known in the arts. Connected to this inner layer is an outer ‘skin’ layer comprising light weight elastic quality material that in a preferred embodiment is fitted with layered rows of natural and/or synthetic feathers. In a further particularly preferred embodiment, the soaring platform conception in-part considers the effect and benefit of taking into account the physics of solid objects to gas phase interactions. When one considers the streaming of air across the surface of a solid body such as an aircraft fuselage, it is well known that eddies or corialis vortices manifest themselves ultimately causing resistance of air flow, a subsequent build up of air molecules about the fuselage, and a negative impact on flight. To overcome such friction related issues, nature has provided the bird with a body of ‘hair-like’ projections known as feathers that provide for an ideal interface between solid and gas phase. The feathers actually help slip-stream air molecules along and past the surface of the body and wing itself, and in the instant case the body of the soaring platform. The slip stream or ‘wetting’ factor is similar to the effect of scales of a shark wherein the scales capture air molecules and provide for the shark to essentially slip near frictionless through the water in a cushion of air as opposed to having to push against sticky water molecules. The feathers can be affixed by any number of means including stitching, gluing, and/or weaving into fabric. The ventral portion of the outer vest layer can be baggy or oversized in appearance because of the expectation of expanding the buoyancy pockets to an appropriate volume. It is contemplated to close up, such as by zipping, buckling or otherwise affixing together the left and right outer vest later prior to charging the buoyancy pockets with gas.

The aftward portion of the body harness comprises the foot pedal spar, rudder and rudder articulation mechanism. The forward end of the rudder/foot pedal spar is attached to the main body harness by a hinge configuration 450 that is spring loaded to resist articulation of the spar in relation to the body harness. If an appropriate level of force is applied to the spar, the hinge will ‘give’ under continued force and articulate in only one direction, namely ventrally. In further embodiments, the foot pedal spar at the area of the pilot's thighs has seatbelt like retractable belt that connects to the dorsal side of both left and right thigh wraps and further to the lateral sides of the forward portions of the body harness thigh portion so as to make the tension from the belt evenly distributed on the pilots thighs. This belt system allows for the pilots legs to be maintained in-line with the rest of the pilots body when lying prone in flight. The tension of the belt is adjustable and releaseable at will by manipulating spring drives in the ‘seat belt’ mechanism. In a preferred embodiment, the belt tensioning can be manipulated by use of the reciprocator forward and aft ward release cable levers 400 and 401 that communicates via wire to the spring tension mechanism. The tension is tight during flight keeping the pilot's thighs near the spar. Alternatively, during movements which require a downward positioning or sweeping of the rudder dorsally, particularly during a landing maneuver, the pilot can use his abdomen muscles to apply force to the foot pedal spar, overcome the spring hinge tension and cause the foot pedal spar to swing ventrally. During the dynamic movement of the sweep, the pilot can activate the clutch lever and release the belt tension to allow the legs of the pilot to swing away from the spar to assist in landing on the pilot's feet. In other maneuvers where the rudder is swept downward, the pilot need not use his abdomen muscles to articulate the foot pedal spar but instead only need manipulate the foot pedal to achieve the downward rudder movement necessary for the particular maneuver. Alternatively, where the rudder must be articulated severely as in landing, but not for landing purposes, the foot pedal is equipped with an ‘overdrive’ mechanism which allows the batten to be articulated severely without having to articulate the spar itself.

Foot pedal drive. The foot pedal spar 500 is configured structurally to provide for not only robust connection with the body harness and thigh belt tension unit, but also a robust strength to handle longitudinal as well as lateral pressures that are applied by the pilot's leg and foot muscles. It is contemplated that the spar leading aft from the body harness hinge area can be configured in numerous formats including use of mechanisms to articulate the rudder including electric, hydraulic, and manual driven mechanisms. In embodiments using manual drives, the foot petal spar and mechanism can be configured as depicted in FIG. 15, for example, wherein the spar 500 leading forward from the pedal 501 is a hollow shaft. At the distal (pedal) end the pedal 501 is actually two bicycle-like pedals that are stirrup-like and affixed to an axel 502 lying 90 degrees to the spar 500 length. The pedal axel fits through the spar and will rotate either clockwise (forward, toes down) or counterclockwise (backward, heals down) depending on the pilot's desired foot position. The pedal 501 can further be constructed so as to allow a secure fitting of the pilot's foot to the pedal similar to a bicyclist's pedal shoe sole grommet The secure fitting will allow stability of use in flight yet allow easy separation of the foot from the pedal as desired. Because the pedal 501 is affixed to the axel 502, when pressure is applied to rotate the pedal clockwise or counterclockwise the axel will also rotate. Attached to the axel on the interior of the spar tube 500 is a tang 503 to which is moveably connected to a distal end of a push/pull rod 504 leading forward within the spar 500. The push rod 504 is held slidably and rotatably in place in the central portion of the spar shaft by rod position maintainers 505A and 505B. Near the proximal end of the rod 504, but not at the end, is a second tab 506 comprising the leverage end of a S2 cam system S2v cam 507 movably connected to the rod 504. In this S2 cam system S2v cam 507 mates with single tongue shaped S2t cam 508. The cams are fixed in a keeper housing 509 to which are connected cam axels 510 and 511. Each of cams 507 and 508 can rotate about their respective axels. The nature of the cams' interaction is that when the foot pedal axel 502 is rotated forward or toes down, for example, the push rod will urge cam 507 to rotate causing cam 508 to rotate in the opposite direction. In the present configuration, when the pedal is rotated forward, cam 508 rotates upward. Attached to cam 508 is lever arm 513 which will lift the rudder battens when the foot pedal is rotated toes down and will pull down on the rudder battens when the foot pedal is in the heals down position. With respect to the S2 cam system of this rudder mechanism, the cam tooth and groove shape are specially designed to accommodate providing leverage in both directions of rotation of the cams. Whereas the S2 cam systems employed for dousing the wing spars were able to rotate about an arc range of up to ninety degrees, the cam design here must be slightly adjusted to provide for the tooth to slide against the groove cam in a 180 degree swing.

Concerning the rudder controlling S2 cams, the spar tube 500 has an elongated and wide opening 512 allowing for cams 507 and 508 to protrude through the spar dorsally. In preferred embodiments, cam 508 is attached to the rudder through a lever arm 513. At the proximal end of the push rod 504, the rod bends 90 degrees dorsally through spar opening 512 and is connected to an attachment module 514 comprising the rudder batten proximal ends moveably connected within said module 514.

In a further preferred embodiment, the foot pedal axel 502 and connected push rod 504 can be rotated together by pilot foot pressure applied to the pedal. For example, when the pilot pushes the right pedal forward, the left pedal will move rearward. Thus a pilot can push with the right foot and pull back with the left foot. In making such a movement, the pedal axel 502 rotates and along with it the push rod 504 and rudder module 514. In further related embodiments, the spar tube 500 at the area of the pedal axel has openings 515L and 515R, i.e., left and right openings that are elongate wide slots and allow the pedal axel 502 to swing (looking down the spar 500 forward) clockwise or counterclockwise up to greater than 45 degrees in either direction and to swing up and down as well. This movement allows the rudder to move with the angled pedal axel 502 and since rudder lifting cams 507 and 508 continue to be in the same orientation with the rudder, the cams can be operated to lift or lower the rudder simultaneously while the pedal axel, pushrod and cams are in a rotated position.

In yet another embodiment, the pedal axel 502 can be articulated by pushing down on one side (left or right) while allowing the opposite side to move up. The opening of slots 515R and 515L accommodate this movement. By ‘down’ and ‘up’ is meant that down is below the foot from the perspective of the pilot standing upright. On the inside of the pedal spar 500 the pedal axel 502 has connected thereto on both the right and left sides of the axel and just inside the spar tube 500 with tension lines 516R and 516L. The tension lines are run forward and upward at an angle to opposite sides of the pedal spar interior to a cross rod 517 that is connected to the rudder module 514. In a preferred embodiment, when the axel is pushed down on the right side, for example, the tension line 516R pulls on the opposite side portion of the cross rod 517. In a further embodiment, the rudder module 514 is mounted to the proximal end of the push rod 504 so that it can rotate wherein, viewing the rudder from the dorsal side, it will rotate or swing left and right. For a right peddle down movement, the rudder will be urged to swing towards the right side of the craft. Due to the small measurement or arc of rotation necessary, regardless of the orientation of the push rod and cams, the rudder can still be swept up or down or rotated.

In still another embodiment, the rudder can be made to fan or collapse Fanning and collapsing is brought about by yet another foot pedal modality and movement. Specifically, the pedal axel 502 further accommodates individual foot pedals 501R and 501L on each side that although cannot rotate independently with the axel 502, can ‘slide’ on the axel in and out. The slide in and out of each pedal is not a free movement but is under tension of keeper springs or alternately ratchet like means that allow sliding in a range but semi locked in place by such as a series of bump stops 518R and 518L that hold the pedals towards the center of the axel or allow it to reach a maximum outward position. The pedals are kept from sliding inadvertently by pressure buttons 519R and 519L on the inside side of the pedals which lock the pedal in place on the axel. If the pilot pushes down on the right side pedal for example to cause rudder rotation the pedal will not slip unless the pilot has pushed the pressure button 519R to release the pedal to allow it to slide. In alternate embodiments, no pressure buttons are used and the pilot must learn to consciously keep the pedal in a particular attitude.

In a preferred embodiment, the rudder is fanned by spreading the feet apart towards the outsides of the axel. The fanning is accommodated by tension wires 520R and 520L that lead into the pedal spar 500 and are directed around pulley wheels 521R and 521L that are connected to the push rod 504, and then forward up the spar interior to the opening 512 where they are directed out of the spar by pulley wheels 522R and 522L that are attached to the proximal end of the rod. The tension wires 520R and 520L are led to a third opposed pair of pulley wheels 523R and 523L that are connected to lateral projections 524R and 524L which are attached to the rudder 514 housing. The tension wires 520R and 520L connect to left and right rudder linkages 525R and 525L that run to the connectors for the rudder batten quills.

The rudder module 514 comprises in one preferred embodiment a multiplicity of rods 526 of sufficient length to slide onto the quill portions of the rudder battens. In a preferred embodiment, the number of rudder rods depends on the number of desired rudder battens. This number is typically based on the feather configuration of the particular avian species around which the soaring platform is designed. The battens are removably attached to the rods 526. The rudder attachment rods are attached loosely to a base 527 that is above the terminal portion of the push rod 504 by means of an anchor bar 528. The attachment is that of the bar translating through eyes 529 formed at the end of the rods 526. This configuration allows the battens to raise, lower, freely flex to the side and possess a slight degree of wobble in the capacity to slightly flex or twist. In preferred embodiments, the rudder linkages 525R and 525L comprise a series of elongate loops that interconnect one at a time like a chain formed from connecting paper clips. The loop of each link encircles each batten connector rod. There are as many interconnected loops as there are battens and the battens of each side are connected together but not to battens of the opposite side. In a further embodiment, the rudder battens are urged to a default position by springs connecting each batten rod from the centerline of the rudder. Thus, there is a natural tendency for the rudder to default to a closed position but the degree of closure can be predesigned to an appropriate default position. It is contemplated that a closed or near closed rudder will assist straight line wing articulating flight.

The fanning of the rudder further provides an additional feature in that if the pilot desires to make a split tail so that there is a gap in the middle of a fanned rudder, the pilot will spread his feet out to an extreme position which cannot be achieved unless the pilot pushes the pedal to an override position which can be felt as the feet spread outward on the pedal axel.

In yet another embodiment, the rudder is urged to remain in an up position if the pilot is in a standing position and no foot pressure is applied to the foot spar. The urging arises from a tension spring connected to a second tang 130 on the pedal axel that will make it rotate forward in the toes down position. Under such condition, the rudder will rise. This aspect provides for being able to walk in the platform without having to keep bent over to keep the rudder battens from scraping the ground.

In still additional embodiments, the foot pedals and push rod mechanism rides on a spring loaded support bar 530. This aspect provides for a pogo stick-like springy quality to the placement of the feet on the pedals. This spring aspect further provides for the rudder mechanism to be defaulted in a forward or upward position in the spar when not in use further aiding the keeping of rudder battens off of the ground. In additional aspects, the pilot can apply downward force on the pedal to a position where the rudder mechanism is allowed to slide into an over extended down rudder position which can assist where extreme rudder down motion is desired.

Buoyancy Compensation System. The soaring platform comprises a novel system for lessening the apparent dead weight of the platform. As Depicted in FIGS. 2 and 7C, the buoyancy compensation system comprises a multiplicity of gas impermeable pockets such as aluminum anodized Mylar'*, i.e., material used in manufacturing party balloons. In a preferred embodiment, the gas pockets generally are positioned to support the wings and the center of the platform. In particularly preferred embodiment, the buoyancy system can comprise dorsal pocket B, dorsal leg pocket C, ventral body and thigh length left and right pockets A, and left and right wing pockets D, all of which are connected to a central purge port that can be rotated during purging to individually fill each gas pocket separately. It is further contemplated that the platform can include carrying of a small container of compressed lighter than air gas with in flight capability to adjust gas pocket fill levels by both filling or releasing gas from the individual pockets.

Helmet and Electronics System. As shown in FIGS. 19A, B, and C, in preferred embodiments, the soaring platform further can comprise an electronics system that includes a finger touch pad accessible in the hand gimbals pocket. Keyboard-like touch pads can be placed at both left and right gimbals. The touch pad can be used in connection with radio/telephone and/or with the audio and video of a heads-up display. The pilot helmet is configured to comprise a cap and face covering of substantial size about the frontal face area of a pilot. The lower area of space in front of the face comprises the heads-up display 601. Above the display is a wind screen 602 which is shaped in two lobes to resemble from the exterior the eyes of a bird. The heads-up display is designed to provide via appropriate software, dynamic data (including audio) on altitude including rate of change of climb or descent, wind speed, air speed, ground speed, GPS, horizon indicator, status of reciprocator spring winding, telephone call information such as contact list, ID of caller or person called, and other data available from radio or satellite signal. Where the soaring platform is equipped with camera and video equipment and/or weaponry, the heads up display includes access to the imagery stream from the cameras. This is particularly useful where the camera system comprises infra red or light gathering-based imagery which will allow the pilot to operate the craft in low light or night conditions. Further, where the equipment is weaponry, the heads-up display elements are configured to have the targeting system follow the pilot's eye focus so that the target can be quickly captured and illuminated by the pilot tripping the weapon trigger via the touch pad. Additional features of the helmet include semi permanent mounting of the helmet to the back plate via double hinges 603 and 604 which allow the helmet to be swiveled back over the head in two degrees of movement. Attachment of the helmet to the back plate further allows use of such a large head covering without strain on the pilot's head and neck muscles. Additionally, it is contemplated that the helmet material can comprise light materials such as Styrofoam.

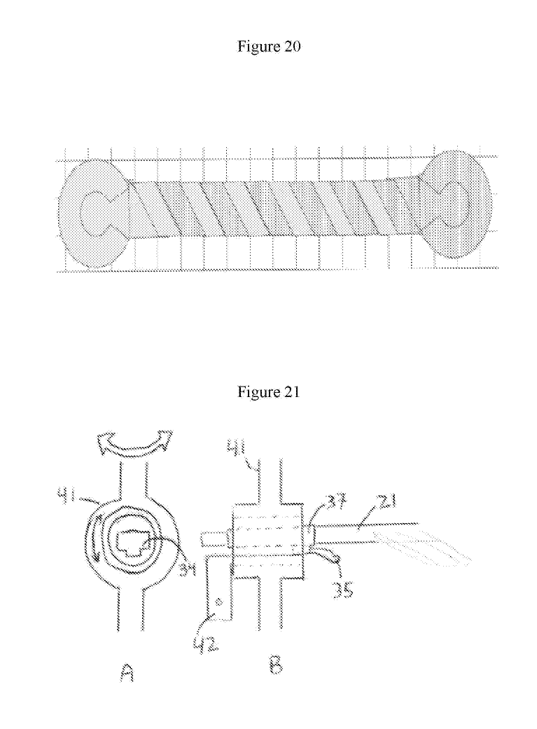

Structural Embodiments. Among the aspects of the soaring platforms construction is the design of structural components. By structural is meant the wing spar sections, body harness, foot pedal spar and battens. It is contemplated that many if not most structural components can be formed into desired shapes using moldable carbon fiber or other composite materials. In one embodiment, considering the factor of high forces acting on the wing spars, it is contemplated to engineer flexibility into the spar construction. In one such method, the spar material can be molded or cut to spiral tongues 650 as shown in FIG. 20. It is contemplated that opposing ends of the spar lengths can be screwed together such that the connection points between the mating opposing pieces for a spiral ridge about the interior and/or exterior of the spar. This construct will not only allow some degree of spring to twisting forces on the spar but will allow for the spar to be manufactured using thinner walls as the spiral ridge provides substantial strength to the rigidity of the tubular spar. Alternatively, as disclosed earlier, beta keratin can be formed into workable sheet and other structural shapes. It is a preferred embodiment to use beta keratin based materials for air foil materials as these can provide the most robust and lightest constructs potentially over that of carbon fiber.

Military applications. The ability to operate the current platform allows for its application to military settings. In a preferred embodiment, the platform can be used as a camera platform wherein the undercarriage or area in front of the pilot can be fitted with structures for mounting said cameras. In an alternate embodiment, the undercarriage structure can comprise a mounting frame for mounting a rifle, such as a 50 caliber or a 0.338 caliber, or any other useful caliber of projectile, wherein the mounting frame is motor driven and works with heads up display software that can aim the weapon by following the pilots eye position. Triggering the weapon can be by use of the key pad.

Examples of how to use. As will be understood by one of skill in the aeronautic arts, the present soaring platform can be employed as a scaffold for building a flyable replica of any soaring bird species. It will be understood that for an individual to fly the platform, he/she will have to learn in a controlled environment how to best manipulate the platforms flight controls. Generally, a pilot will launch the platform from an elevated position such as a hill side or cliff face. However, it is also contemplated that under the right conditions, the pilot may be able to launch the platform from a standing or running position while an automatic repetitious articulation of the wings is performed.

Given the high level of maneuvering capabilities of the platform and the position of the pilot next to the wing it is contemplated that a pilot will have the ability to dive, roll, perform spirals and loops, spin, helicopter, and make virtually any movement a bird can make. The great added advancement with this platform system is that with articulation of the wing, the pilot can use the platform to travel a distance without the benefit of or need to rely strictly on upward drafting air.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the spirit and scope of the invention. More specifically, the described embodiments are to be considered in all respects only as illustrative and not restrictive. All similar substitutes and modifications apparent to those skilled in the art are deemed to be within the spirit and scope of the invention as defined by the appended claims.

All patents, patent applications, and publications mentioned in the specification are indicative of the levels of those of ordinary skill in the art to which the invention pertains. All patents, patent applications, and publications, including those to which priority or another benefit is claimed, are herein incorporated by reference to the same extent as if each individual publication was specifically and individually indicated to be incorporated by reference.

The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. The terms and expressions which have been employed are used as terms of description and not of limitation, and there is no intention that use of such terms and expressions imply excluding any equivalents of the features shown and described in whole or in part thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A Personal Soaring Platform (PSP) comprising:
a. A body harness, said body harness possessing a dorsal portion, a ventral portion, and a rudder control portion;
b. At least a pair of articulatable wing spars in working communication with a reciprocator, said reciprocator adjustably attached to said dorsal portion of said body harness and capable of articulating said wing spars;
c. A bird-like rudder adjustably attached to said rudder control portion wherein said rudder control portion comprises a single spar rotatably attached to said body harness; and
c. Means for controlling articulation of said wings and rudder.

2. The PSP of claim 1 wherein there are at least two wing spars and a single aft rudder spar wherein a pilot can articulate the at least two wing spars at will and wherein the wing spars and rudder spar support a multiplicity of feather-like battens and said platform supports a flyable structure resembling an avian species.

3. The PSP of claim 2 wherein each of said wing spars comprise between one and three hinges that allow said spars to be folded or otherwise collapsed with respect to itself, and wherein said folding or collapsing can be partially performed in-flight.

4. The PSP of claim 3 wherein said folding in-flight is carried out in-part by means comprising S2 cams.

5. The PSP of claim 4 wherein said platform comprises 1) a single spar structure per wing that comprises three sections connected by said hinges wherein the relative lengths of each spar sections mimic the natural ratio between an avian species humerus, radius, and carpal; 2) a body/leg harness; 3) a singular aftward spar comprising at least a foot-operated pedal for rudder manipulation; 4) an air foil batten system for each of the wings and rudder; 5) a wing articulation reciprocator system; 6) a wing articulating hand gimbal steering system; and 7) a wing surface area dousing system comprising means for partially collapsing said wing spars in flight.

6. The PSP of claim 5 further comprising a buoyancy compensation system and an electronics system, said electronics system comprising at least a heads-up helmet screen display and touchpad keyboard for toggling through data displayed on said helmet screen display.

7. The PSP of claim 5 further comprising means for attaching equipment or secondary personnel selected from the group consisting of telescopic capable cameras, light projectile weaponry and body and leg straps.

8. The PSP of claim 3 wherein said wing spars, aft spar and parts thereof comprise material selected from the group consisting of carbon fiber, aluminum, titanium and steel.

9. The PSP of claim 3 further comprising air foils movably attached to said wing spars wherein said air foils comprise a multiplicity of individual battens, said battens formed in feather shaped structures comprising a curved planar section and a non linear support spar.

10. The PSP of claim 9 wherein said battens comprise material selected from the group consisting of carbon fiber and beta Keratin.

11. The PSP of claim 3 wherein said PSP has a wingspan of between 25 and 37 feet and an airfoil area of greater than 15 square meters.

12. The PSP of claim 3 wherein said articulation of said wing spars comprises any of avian-like wing flapping, in-flight partial wing collapsing, in-flight wing spar rotation with respect to oncoming air stream, and rotation of air foil battens movably attached to distal portions of said wing spars.

13. The PSP of claim 3 wherein said articulation of said rudder comprises fanning of rudder battens, rotating of rudder battens, linear alignment of rudder battens, and lateral positioning of rudder battens.

14. The PSP of claim 3 wherein said reciprocator comprises translation of mechanical motion in a first plane to motion in a second plane.

15. The PSP of claim 14 wherein said motion in a first plane is parallel to a pilot's body and motion in said second plane is between 70 to 90 degrees out of said first plane and away from said pilot's body.

16. The PSP of claim 15 wherein said reciprocator is driven by a windable spring.

17. The PSP of claim 15 wherein said reciprocator is driven by an electronic servo motor.

18. The PSP of claim 6 wherein said buoyancy compensation comprises a multiplicity of bladders fillable with lighter than air gases selected from Hydrogen and Helium.

19. The PSP of claim 3 wherein said PSP is steerable using a foot operated pedal to manipulate said rudder and hand gimbals to operate articulation of said wing spars.
